SEQUENCE LISTING (62 sequences)

SEQ ID NO: 1 - protein, 124 aa, Artificial Sequence
  synthetic anti-phosphotyrosine reference chimeric heavy chain V-region Fab expression clone KB6109
EVQLQQSGPELVKPGASVKISCKTSGYTFTEYTMHWMKQSHGKSLEWMGGINPNSGGTRDNQRFKGKATLTVDKSSSIAYMELRSLTSEDSAVYYCARRGPYGNYYNSYYFDYWGQGTTLTVSS

SEQ ID NO: 2 - protein, 124 aa, Artificial Sequence
  synthetic anti-phosphotyrosine optimized reference chimeric heavy chain V-region Fab expression clone KB6110
QVQLVQSGAELVKPGASVKISCKTSGYTFTEYTMHWMKQSHGKSLEWMGGINPNSGGTRDNQRFKGKATLTVDKSSSIAYMELRSLTSEDTAVYYCARRGPYGNYYNSYYFDYWGQGTLVTVSS

SEQ ID NO: 3 - protein, 107 aa, Artificial Sequence
  synthetic anti-phosphotyrosine reference chimeric kappa light chain V-region Fab expression clone KB6109
DVQMTQTTSSLSASLGDRVTISCSASQGISNYLNWYQQKPDGTVKLLIYYTSSLHSGVPSRFSGSGSGTDYSLTISNLEPEDVATYYCQQYSKVPWTFGGGTKLEIK

SEQ ID NO: 4 - protein, 107 aa, Artificial Sequence
  synthetic anti-phosphotyrosine optimized reference chimeric kappa light chain V-region Fab expression clone KB6110
DIQMTQTTSSLSASLGDRVTISCSASQGISNYLNWYQQKPDGTVKLLIYYTSSLHSGVPSRFSGSGSGTDYSLTISNLEPEDFATYYCQQYSKVPWTFGQGTKLEIK

SEQ ID NO: 5 - protein, 49 aa, Artificial Sequence
  synthetic PTyr-BSA binding murine anti -phosphotyrosine MAb PY20 heavy chain ′front′ cassette reference sequence
EVQLQQSGPELVKPGASVKISCKTSGYTFTEYTMHWMKQSHGKSLEWMG

SEQ ID NO: 6 - protein, 49 aa, Artificial Sequence
  synthetic PTyr-BSA binding human Vh1 subclass heavy chain ′front′ cassette PY294-28D
EVQLVQSGAEVKQPGASVKVSCKASGYTFTNYTMHWVRQAPGQRLEWMG

SEQ ID NO: 7 - protein, 49 aa, Artificial Sequence
  synthetic PTyr-BSA binding human Vh1 subclass heavy chain ′front′ cassette PY604VH1
EVQLVQSGAEVKKPGASVKVSCKASGYTFTSYTIHWVRQAPGQRLEWMG

SEQ ID NO: 8 - protein, 49 aa, Artificial Sequence
  synthetic PTyr-BSA binding human Vh1 subclass heavy chain ′front′ cassette PY604VH2
EVQLVQSGAEVKKPGASVKVSCKASGYTFTGYTIHWVRQAPGQGLEWMG

SEQ ID NO: 9 - protein, 49 aa, Artificial Sequence
  synthetic PTyr-BSA binding human Vh1 subclass heavy chain ′front′ cassette PY604VH5
EVQLVQSGAEVKKPGASVKVSCKASGYTFTNYTLHWVRQAPGQRLEWMG

SEQ ID NO: 10 - protein, 39 aa, Artificial Sequence
  synthetic PTyr-BSA binding murine anti -phosphotyrosine MAb PY20 light chain ′front′ cassette reference sequence
DVQMTQTTSSLSASLGDRVTISCSASQGISNYLNWYQQK

SEQ ID NO: 11 - protein, 39 aa, Artificial Sequence
  synthetic PTyr-BSA binding human VkappaI subclass light chain ′front′ cassette VL-FE2
DIQLTQSPSSLSASVGDRVTITCQASQDISRSLNWYQQK

SEQ ID NO: 12 - protein, 39 aa, Artificial Sequence
  synthetic PTyr-BSA binding human VkappaI subclass light chain ′front′ cassette VL-FE3
DIQLTQSPSSLSASVGDRVTITCRASQSINNYLNWYQQK

SEQ ID NO: 13 - protein, 39 aa, Artificial Sequence
  synthetic PTyr-BSA binding human VkappaI subclass light chain ′front′ cassette VL-FE4
DIQLTQSPSSLSASVGDRVTITCRASQSISRYLNWYQQK

SEQ ID NO: 14 - protein, 39 aa, Artificial Sequence
  synthetic PTyr-BSA binding human VkappaI subclass light chain ′front′ cassette VL-FE5
DIQLTQSPSSLSASVGDRVTITCRASQSINSYLNWYQQK

SEQ ID NO: 15 - protein, 39 aa, Artificial Sequence
  synthetic PTyr-BSA binding human VkappaI subclass light chain ′front′ cassette VL-FE6
DIQLTQSPSSLSASVGDRVTITCRASQRINNYLNWYQQK

SEQ ID NO: 16 - protein, 39 aa, Artificial Sequence
  synthetic PTyr-BSA binding human VkappaI subclass light chain ′front′ cassette VL-FE7
DIQLTQSPSSLSASVGDRVTITCRASQSISGYLNWYQQK

SEQ ID NO: 17 - protein, 39 aa, Artificial Sequence
  synthetic PTyr-BSA binding human VkappaI subclass light chain ′front′ cassette VL-FE8
DIQLTQSPSSLSASVGDRVTITCRASQSIGNYLNWYQQK

SEQ ID NO: 18 - protein, 48 aa, Artificial Sequence
  synthetic PTyr-BSA binding murine anti -phosphotyrosine MAb PY20 light chain ′middle′ cassette reference sequence
DGTVKLLIYYTSSLHSGVPSRFSGSGSGTDYSLTISNLEPEDVATYYC

SEQ ID NO: 19 - protein, 48 aa, Artificial Sequence
  synthetic PTyr-BSA binding human VkappaI subclass light chain ′middle′ cassette VL1 MD
GKAPKLLIYAASSLYSGVPSRFSGSGSGTDFTLTINSLQPEDFATYYC

SEQ ID NO: 20 - protein, 48 aa, Artificial Sequence
  synthetic PTyr-BSA binding human VkappaI subclass light chain ′middle′ cassette VL2 MD
GKAPKLLIYAASKLHSGVPSRFSGSGSGTDFTLTISSLQPEDIATYYC

SEQ ID NO: 21 - protein, 48 aa, Artificial Sequence
  synthetic PTyr-BSA binding human VkappaI subclass light chain ′middle′ cassette VL4 MD
GKAPKLLIYAATSLHSGVPSRFSGSGSGTDFTLIISSLQPEDVATYYC

SEQ ID NO: 22 - protein, 48 aa, Artificial Sequence
  synthetic PTyr-BSA binding human VkappaI subclass light chain ′middle′ cassette VL6 MD
GKAPKLLIYTASSLHTGVPSRFSGSGSGTDFSLTINSLQPEDVATYYC

SEQ ID NO: 23 - protein, 88 aa, Artificial Sequence
  synthetic PTyr-BSA binding murine anti -phosphotyrosine MAb PY20 light chain full chain V-segment reference sequence
DVQMTQTTSSLSASLGDRVTISCSASQGISNYLNWYQQKPDGTVKLLIYYTSSLHSGVPSRFSGSGSGTDYSLTISNLEPEDVATYYC

SEQ ID NO: 24 - protein, 88 aa, Artificial Sequence
  synthetic PTyr-BSA binding human VkappaI subclass light chain full chain V-segment VL FC1
DIQLTQSPSSLSASVGDRVTITCRASQSIRSYLNWYQQKPGKAPKLLIYTASSLPSGVPSRFSGSGSGTDFTLTISSLQPEDFATYYC

SEQ ID NO: 25 - protein, 88 aa, Artificial Sequence
  synthetic PTyr-BSA binding human VkappaI subclass light chain full chain V-segment VL FC2
DIQMTQSPSSLSASVGDRVTITCRASQSINNRLNWYQQKKGKAPNLLIYAASNLQSGAPSRFSGSGSGTDFTLTISSLQPEDIATYYC

SEQ ID NO: 26 - protein, 88 aa, Artificial Sequence
  synthetic PTyr-BSA binding human VkappaI subclass light chain full chain V-segment VL FC5
DIQLTQSPSSLSASVGDRVTITCRASQSISRNLNWYQQKPGKAPKILIYTASNLQSGVPSRFSGSGSGTDFTLTISSLQPEDFATYYC

SEQ ID NO: 27 - protein, 88 aa, Artificial Sequence
  synthetic PTyr-BSA binding human VkappaI subclass light chain full chain V-segment VL FC9
DIQLTQSPSSLSASVGDTVTITCRANQNIKGYLNWYQQKPGKAPQLLIYTVSTLQSGVPSRFSGSGYGTDFTLTISTLQPEDFATYYC

SEQ ID NO: 28 - protein, 88 aa, Artificial Sequence
  synthetic PTyr-BSA binding human VkappaI subclass light chain full chain V-segment VL FC9
DIQLTQSPSSLSASVGDRVTITCRASQSIRTYLNWYQQKPGKAPRLLIYAASSLQSGVSSRFSGSGSGSDFTLTISSLQPEDFATYYC

SEQ ID NO: 29 - protein, 88 aa, Artificial Sequence
  synthetic PTyr-BSA binding human VkappaI subclass light chain full chain V-segment VL FC11
DIQLTQSPSSLSASVGDRVTITCRASQSIRNYLNWYQQKPGKAPKLLIYAASTLHSGVPSRFSGSGSGTDFTLTISSLQPEDFATYYC

SEQ ID NO: 30 - protein, 19 aa, Artificial Sequence
  synthetic PTyr-BSA binding murine anti -phosphotyrosine MAb PY20 light chain LCDR3/FR4 reference sequence
QQYSKVPWTFGGGTKLEIK

SEQ ID NO: 31 - protein, 19 aa, Artificial Sequence
  synthetic PTyr-BSA binding human light chain LCDR3/F4 3P1C CDR3/F4
QQYRKVPWTFGGGTKLEIK

SEQ ID NO: 32 - protein, 19 aa, Artificial Sequence
  synthetic PTyr-BSA binding human light chain LCDR3/F4 PY237-C6
QQYKSPPWTFGQGTKVEIK

SEQ ID NO: 33 - protein, 19 aa, Artificial Sequence
  synthetic PTyr-BSA binding human light chain LCDR3/F4 PY237-B3
QQSYSTPWTFGQGTKVEIK

SEQ ID NO: 34 - protein, 19 aa, Artificial Sequence
  synthetic PTyr-BSA binding human light chain LCDR3/F4 PY237-B4
QQYKTEPWTFGQGTKVEIK

SEQ ID NO: 35 - protein, 19 aa, Artificial Sequence
  synthetic PTyr-BSA binding human light chain LCDR3/F4 PY237-H12
QQSYSSPRTFGQGTKVEIK

SEQ ID NO: 36 - protein, 26 aa, Artificial Sequence
  synthetic PTyr-BSA binding murine anti -phosphotyrosine MAb PY20 heavy chain HCDR3/FR4 reference sequence
RGPYGNYYNSYYFDYWGQGTTLTVSS

SEQ ID NO: 37 - protein, 26 aa, Artificial Sequence
  synthetic PTyr-BSA binding human heavy chain HCDR3/F4 3P1C CDR3/F4
RGPYGNLYNSYYFDYWGQGTTLTVSS

SEQ ID NO: 38 - protein, 25 aa, Artificial Sequence
  synthetic PTyr-BSA binding human heavy chain HCDR3/F4 PY241-2-6G
RVTAARNTGYYFDYWGQGTLVTVSS

SEQ ID NO: 39 - protein, 24 aa, Artificial Sequence
  synthetic PTyr-BSA binding human heavy chain HCDR3/F4 PY241-2-14C
RDGYTNRWYYFDYWGQGTLVTVSS

SEQ ID NO: 40 - protein, 25 aa, Artificial Sequence
  synthetic PTyr-BSA binding human heavy chain HCDR3/F4 PY241-2-1D
RGGRGDSSGYYFDYWGQGTLVTVSS

SEQ ID NO: 41 - protein, 31 aa, Artificial Sequence
  synthetic PTyr-BSA binding human heavy chain HCDR3/F4 PY241-2-8G
RVRGYYYDSSGYHKRYYFDYWGQGTLVTVSS

SEQ ID NO: 42 - protein, 32 aa, Artificial Sequence
  synthetic PTyr-BSA binding human heavy chain HCDR3/F4 PY241-2-15C
RGPKNSGSYFGGEMGTYYFDYWGQGTLVTVSS

SEQ ID NO: 43 - protein, 24 aa, Artificial Sequence
  synthetic PTyr-BSA binding human heavy chain HCDR3/F4 PY241-2-17D
RDSGSYFGYYFDYWGQGTLVTVSS

SEQ ID NO: 44 - protein, 33 aa, Artificial Sequence
  synthetic PTyr-BSA binding human heavy chain HCDR3/F4 PY241-2-22H
RSRSSLLRFLEWLSNKKYYFDYWGQGTLVTVSS

SEQ ID NO: 45 - protein, 26 aa, Artificial Sequence
  synthetic PTyr-BSA binding human heavy chain HCDR3/F4 PY241-2-20H
RGPSSGWYSFYYFDYWGQGTLVTVSS

SEQ ID NO: 46 - protein, 32 aa, Artificial Sequence
  synthetic PTyr-BSA binding human heavy chain HCDR3/F4 PY241-2-16B
RGGMVVAATGFRESPTYYFDYWGQGTLVTVSS

SEQ ID NO: 47 - protein, 22 aa, Artificial Sequence
  synthetic antibody PY3A and PY9E defined epitope
IETLVDIFQEYPDEIEYIFKPS

SEQ ID NO: 48 - protein, 107 aa, Artificial Sequence
  synthetic anti-phosphotyrosine mouse monoclonal antibody PY20 light chain V-region
DVQMTQTTSSLSASLGDRVTISCSASQGISNYLNWYQQKPDGTVKLLIYYTSSLHSGVPSRFSGSGSGTDYSLTISNLEPEDFATYYCQQYSKVPWTFGGGTKLEIK

SEQ ID NO: 49 - protein, 124 aa, Artificial Sequence
  synthetic anti-phosphotyrosine mouse monoclonal antibody PY20 heavy chain V-region
QVQLQQSGPELVKPGASVKISCKTSGYTFTEYTMHWMKQSHGKSLEWMGGINPNSGGTRDNQRFKGKATLTVDKSSSIAYMELRSLTSEDSAVYYCARRGPYGNYANSYYFDYWGQGTTVTVSS

SEQ ID NO: 50 - protein, 15 aa, Artificial Sequence
  synthetic PTyr-BSA binding reference Fab clone KB6109 and clone 2P16D HCDR3
RGPYGNYYNSYYFDY

SEQ ID NO: 51 - protein, 9 aa, Artificial Sequence
  synthetic PTyr-BSA binding reference Fab clone KB6109 LCDR3
QQYSKVPWT

SEQ ID NO: 52 - protein, 15 aa, Artificial Sequence
  synthetic PTyr-BSA binding Fab clone 1P6D HCDR3
RGPYGNRYNSYYFDY

SEQ ID NO: 53 - protein, 9 aa, Artificial Sequence
  synthetic PTyr-BSA binding Fab clone 1P6D LCDR3
QQYSKTPWT

SEQ ID NO: 54 - protein, 15 aa, Artificial Sequence
  synthetic PTyr-BSA binding Fab clone 1P8D HCDR3
RGPRGNYYNSYYFDY

SEQ ID NO: 55 - protein, 9 aa, Artificial Sequence
  synthetic PTyr-BSA binding Fab clone 1P8D LCDR3
QQYSKAPWT

SEQ ID NO: 56 - protein, 15 aa, Artificial Sequence
  synthetic PTyr-BSA binding Fab clone 2P7A HCDR3
RGPYGNYYNRYYFDY

SEQ ID NO: 57 - protein, 9 aa, Artificial Sequence
  synthetic PTyr-BSA binding Fab clone 2P7A LCDR3
QQYSKQPWT

SEQ ID NO: 58 - protein, 15 aa, Artificial Sequence
  synthetic PTyr-BSA binding Fab clone 2P13C HCDR3
RGPYGQYYNSYYFDY

SEQ ID NO: 59 - protein, 9 aa, Artificial Sequence
  synthetic PTyr-BSA binding Fab cloneS 2P13C, 3P1C, and 2P16D LCDR3
QQYRKVPWT

SEQ ID NO: 60 - protein, 15 aa, Artificial Sequence
  synthetic PTyr-BSA binding Fab clone 3P1C HCDR3
RGPYGNLYNSYYFDY

SEQ ID NO: 61 - protein, 15 aa, Artificial Sequence
  synthetic PTyr-BSA binding Fab clone 3P14A HCDR3
RGPYGNSYNNYYFDY

SEQ ID NO: 62 - protein, 9 aa, Artificial Sequence
  synthetic PTyr-BSA binding Fab clone 3P14A LCDR3
QQYSHVPWT

(19) United States
(12) Patent Application Publication
(10) Pub. No.: US 2011/0245100 A1
(43) Pub. Date: Oct. 6, 2011

(54) GENERATION OF ANTIBODIES TO AN EPITOPE OF INTEREST

(75) Inventors: Geoffrey T. Yarranton, South San Francisco, CA (US); Kenneth Luehrsen, South San Francisco, CA (US); Christopher R. Bebbington, South San Francisco, CA (US); Nenad Tomasevic, South San Francisco, CA (US)

(73) Assignee: KaloBios Pharmaceuticals, Inc., South San Francisco, CA (US)

(21) Appl. No.: 13/079,641

(22) Filed: Apr. 4, 2011

Related U.S. Application Data
(60) Provisional application No. 61/320,622, filed on Apr. 2, 2010.

(51) Int. Cl. C40B 30/04

(52) U.S. Cl. 506/9

(57) ABSTRACT

The invention provides methods of obtaining antibodies to an epitope of interest based on an anti-hapten focused library.

### CROSS-REFERENCE TO RELATED APPLICATIONS

This application claims benefit of U.S. provisional application No. 61/320,622, filed Apr. 2, 2010, which application is herein incorporated by reference in its entirety.

### BACKGROUND OF THE INVENTION

A major challenge in antibody technology is the generation of monoclonal antibodies that selectively bind to a pre-chosen epitope on an antigen of interest. The reason for this is usually due to the fact that proteins often have dominant epitopes (i.e., epitopes that are efficiently recognized by the host immune system) and/or epitopes for which the host immune system is tolerized (treated as a self-antigen). The repertoire of antibodies that bind to an antigen can therefore be quite restricted. A number of strategies are being developed to address this issue including: new adjuvants, chimeric peptides and DNA vaccination (Grunewald et al., Proc. Natl. Acad Sci USA 105:11276-11280, 2008). However, these approaches do not direct the immune response to a defined site on the protein or peptide of interest. Further, these approaches are not performed in vitro, and thus are constrained by the endogenous immune system of the host organism. In vitro methods of de novo antibody generation, e.g., phage display technology, also rely on the use of antibody libraries made from naturally occurring V-region sequences. Such libraries tend to be ‘biased’ due to the in vivo tolerance mechanisms of the host organism from which the V-region libraries were made. The present method overcomes these limitations by providing an in vitro method to generate an antibody to a desired epitope.

### BRIEF SUMMARY OF THE INVENTION

In one aspect, the invention provides a method of obtaining an antibody to an epitope of interest, the method comprising: (a) screening an anti-hapten focused library with a hapten-labeled epitope comprising the epitope of interest joined to a hapten; (b) identifying members of the anti-hapten focused library that bind to the hapten-labeled epitope to generate a sublibrary of the anti-hapten focused library; (c) screening the sublibrary of step (b) with the epitope of interest that is not attached to the hapten; and (d) selecting an antibody that binds to the epitope, thereby obtaining an antibody to the epitope of interest. In some embodiments, the members of the anti-hapten focused library retain a minimal essential binding specificity determinant from the reference antibody CDR1 or CDR2V_{H} and/or V_{L} region. In some embodiments, the members of the anti-hapten focused library retain a minimal essential binding specificity determinant from the reference antibody CDR3V_{H} and/or V_{L} region. In some embodiments, the members of the anti-hapten focused library retain a minimal essential binding specificity determinant from the reference antibody heavy chain CDR2 and a minimal essential binding specificity determinant from the reference antibody light chain CDR3. In some embodiments, the step of screening the anti-hapten antibody library with the hapten-labeled epitope can further comprise screening the anti-hapten antibody library with a hapten comparator molecule; and selecting an antibody that exhibits increased binding to the hapten-labeled epitope relative to the binding to the hapten comparator molecule. In some embodiments, the hapten is a naturally occurring modified amino acid. In some embodiments, the hapten is a modified tyrosine. In some embodiments, the hapten is phosphotyrosine, phosphoserine or phosphothreonine.

In typical embodiments, the method further comprises: (e) selecting one of the V regions of the antibody selected in (d) and exchanging a cassette of the selected V region with a library of corresponding cassettes to provide a library of engineered V regions, wherein the selected V region retains at least one minimal essential binding specificity determinant of a CDR from the antibody selected in (d); (f) pairing the V region library of step (e) with the complementary V region from the antibody selected in step (d) to form a library of antibodies; (g) screening the library of step (f) with the epitope of interest that is not attached to the hapten; and (h) selecting an antibody that binds to the epitope wherein the antibody comprises an engineered V region. In some embodiments, the selected V region is a heavy chain V region. In some embodiments, the at least one minimal binding specificity determinant retained is from a CDR3. In some embodiments, the cassette that is exchanged in step (e) is a CDR3-FR4 cassette.

The method can also comprise additional steps. In some embodiments, the method thus can further comprise: (i) selecting the engineered V region from the antibody selected in step (h) and exchanging another cassette of the engineered V region with a library of corresponding cassettes, wherein the selected V region retains at least one minimal essential binding specificity determinant from a CDR from the antibody selected in (h); (j) pairing the V region library of step (i) with the complementary V region of the antibody selected in (h) to form an antibody library; (k) screening the antibody library of step (j) with an epitope of interest that is not attached to the hapten; and (l) selecting an antibody that binds to the epitope, thereby obtaining an antibody to an epitope of interest.

In some embodiments, the anti-hapten focused library comprises binding members that retain the binding specificity of a reference anti-hapten antibody and comprise at least one heavy chain CDR minimal essential binding specificity determinant from the reference anti-hapten antibody and at least one light chain CDR minimal essential binding specificity determinant from the reference anti-hapten antibody; and have at least one diverse exchange cassette.

In some embodiments, the size of the anti-hapten focused library has a diversity of less than about 10⁸ recombinants. Typically, in the screening methods of the invention about 10⁵ or fewer members of the library are screened. Often, from between about 10³ members to about 10⁴ members or to about 10⁵ members of the library are screened.

In a further aspect, the invention provides a method of obtaining an antibody to an epitope of interest, the method comprising: screening an anti-hapten focused library, e.g.; an anti-hapten focused library that has a diversity of greater than about 10⁹ recombinants, with a hapten-labeled protein antigen where the epitope of interest to which it is desirable to obtain an antibody is labeled with the hapten; and selecting antibodies that bind to the unlabeled protein. The positive clones from the screen are also screened with the unlabeled protein antigen, where the epitope of interest is not labeled with the hapten, and the clones that bind the epitope are selected. In some embodiments, e.g., in some instances where the epitope is a linear epitope, the positive clones may be screened with a peptide, e.g., of less than 50 amino acids in length, comprising the epitope of interest, and those clones that bind better than the unlabeled protein antigen selected. In typical embodiments, the method comprises performing additional steps comprising retaining at least one MEBSD from a CDR from a selected antibody to generate a further diverse library that can be screened for improved binding to the epitope of interest. As understood in the art, a selected antibody may be subject to further rounds of improvement by diversifying various segments of the V_{H} and/or V_{L} regions and retaining an MEBSD from a CDR from the selected antibody. Antibodies that bind the epitope that are selected from the further diverse library can also be used to generate additional diverse libraries until an antibody that has the desired property, e.g., affinity, loss of the hapten binding specificity of the original reference anti-hapten library, is obtained. In typical embodiments, the library has a diversity in the range of about 10⁹ to about 10¹³ recombinants, e.g., typically about 10⁹ to about 10¹⁰ or to about 10¹¹ recombinants. In some embodiments, the hapten is a naturally occurring modified amino acid. In some embodiments, the hapten is a modified tyrosine residue. In some embodiments, the hapten is a phosphotyrosine, phosphoserine, or phosphothreonine.

The methods of the invention described herein are performed using antibody libraries that are in any format suitable for antibody expression and screening. In some embodiments, the library expressed the antibodies in a Fab format. In some embodiments, the antibody is secreted, whereas in other embodiments, the antibody is displayed on the surface of a cell or phage. In some embodiments, the library is screened using a colony lift assay.

### BRIEF DESCRIPTION OF THE DRAWINGS

FIG. 1 shows an amino acid sequence alignment of reference and optimized reference heavy and light chain V-regions. The Fab expression clones for the reference and optimized reference Fabs are named KB6109 and KB6110, respectively. The amino acid changes in the optimized reference KB6110 V-regions are underlined.

FIG. 2 shows representative human heavy chain ‘front’ cassettes that support PTyr-BSA binding. All of the heavy chain ‘front’ sequences are from the human Vh1 subclass. The reference sequence is from the murine Mab PY20. The HCDR1 is boxed.

FIG. 3 shows representative human light chain ‘front’ cassettes that support PTyr-BSA binding. All of the light chain ‘front’ sequences are from the human VkI subclass. The reference sequence is from the murine Mab PY20. The LCDR1 is boxed.

FIG. 4 shows representative human light chain ‘middle’ cassettes that support PTyr-BSA binding. All of the light chain ‘middle’ sequences are from the human VkI subclass. The reference sequence is from the murine Mab PY20. The LCDR2 is boxed.

FIG. 5 shows representative human light chain full chain V-segments that support PTyr-BSA binding. All of the light chain full chain sequences are from the human VkI subclass. The reference sequence is from the murine Mab PY20. The LCDR1 and LCDR2 are boxed. The LCDR3 and FR4 are not shown.

FIG. 6 shows representative human LCDR3/FR4 sequences that support PTyr-BSA binding. The only CDR3/FR4 sequences detected in this screen that support PTyr-BSA binding had a Jκ1 J-region. The reference sequence is from the murine Mab PY20. The LCDR3 is boxed.

FIG. 7 shows representative human HCDR3/FR4 Sequences that support PTyr-BSA binding. For each human HCDR3 an R was engineered at position +1. The only HCDR3/FR4 sequences detected that support PTyr-BSA binding had a JH4 J-region. The dashes represent gaps generated by the alignment software. The HCDR3 is boxed.

FIG. 8 provides data showing the affinity of the antibody PY3A to non-phosphorylated VEGF peptide.

### DETAILED DESCRIPTION OF THE INVENTION

### Definitions

A “hapten” is a small molecule that, when attached to a larger carrier such as a protein, can elicit the production of antibodies that bind specifically to it (in either the free or combined state). A “hapten” is able to bind a preformed antibody, but fails to stimulate antibody generation on its own. In the context of this invention, the term “hapten” includes modified amino acids, either naturally occurring or non-naturally occurring. Thus, for example, the term “hapten” includes naturally occurring modified amino acids such as phosphotyrosine, phosphothreonine, phosphoserine, or sulphated residues such as sulphated tyrosine (sulphotyrosine), sulphated serine (sulphoserine), or sulphated threonine (sulphothreonine); and also include non-naturally occurring modified amino acids such as p-nitro-phenylalanine.

A “hapten-labeled epitope” in the context of this invention refers to a hapten attached to an epitope of interest. The epitope of interest may be a peptide, or the epitope may be present in a longer protein, or a non-protein, such as a carbohydrate. The hapten can be positioned anywhere in the epitope of interest.

An “anti-hapten focused library” in the context of this invention refers to a library of antibodies comprising diverse antibody sequences wherein a member of the library has a heavy chain that comprises at least one CDR minimal essential binding specificity determinant from a reference anti-hapten antibody and/or a light chain that comprises at least one CDR minimal essential binding specificity determinant from the light chain of the reference anti-hapten antibody. The members of the library have different sequences relative to one another. When referring to an “antibody library” or “anti-hapten focused library”, the term refers to not only the collection of antibodies produced by the library, but also to the colonies, phage, and the like that express the antibodies. An anti-hapten focused library can be from an antibody to any hapten, see, e.g., the SuperHapten Database (Gunther et al., Nucl. Acids Res. 35 (Database issue): D906-D910, 2007; website http:// followed by bioinformatics.charite.de/superhapten/); and the HaptenDB (Singh et al., Bioinformatics 2006 22(2):253-255, 2006; website www followed by imtech.res.in/raghava/haptendb).

The terms “competitor hapten” and “comparator hapten” are used interchangeably herein to refer to the hapten in a form where it is not linked to the epitope of interest. Thus, in embodiments, e.g., in which the screening method comprises screening with a comparator hapten, this refers to hapten that is not linked to the epitope of interest; the hapten may, however, be linked to a protein carrier such as bovine serum albumin or a non-peptide carrier, e.g., polyethylene glycol (PEG).

A “sub-library” refers to a collection of clones obtained by screening an initial library for a desirable characteristic, e.g., the ability to bind a hapten-labeled epitope of interest with a higher affinity than the affinity for comparator hapten. In some embodiments, a “sub-library” is subjected to further manipulation prior to screening of the sub-library.

“Repertoire” or “library” refers to a library of genes encoding antibodies or antibody fragments such as Fab, scFv, Fd, LC, V_{H}, or V_{L}, or a subfragment of a variable region, e.g., an exchange cassette, that is obtained from a natural ensemble, or “repertoire”, of antibody genes present, e.g., in human donors, and obtained primarily from the cells of peripheral blood and spleen. In some embodiments, the human donors are “non-immune”, i.e., not presenting with symptoms of infection. In the current invention, a library or repertoire often comprises members that are exchange cassettes of a given portion of a V region.

“Synthetic antibody library” refers to a library of genes encoding one or more antibodies or antibody fragments such as Fab, scFv, Fd, LC, V_{H}, or V_{L}, or a subfragment of a variable region, e.g., an exchange cassette, in which one or more of the complementarity-determining regions (CDR) has been partially or fully altered, e.g., by oligonucleotide-directed mutagenesis. “Randomized” means that part or all of the sequence encoding the CDR has been replaced by sequence randomly encoding all twenty amino acids or some subset of the amino acids.

As used herein, an “antibody” refers to a protein functionally defined as a binding protein and structurally defined as comprising an amino acid sequence that is recognized by one of skill as being derived from an immunoglobulin encoding gene of an animal producing antibodies. An antibody can consist of one or more polypeptides substantially encoded by immunoglobulin genes or fragments of immunoglobulin genes. The recognized immunoglobulin genes include the kappa, lambda, alpha, gamma, delta, epsilon and mu constant region genes, as well as myriad immunoglobulin variable region genes. Light chains are classified as either kappa or lambda. Heavy chains are classified as gamma, mu, alpha, delta, or epsilon, which in turn define the immunoglobulin classes, IgG, IgM, IgA, IgD and IgE, respectively.

A typical immunoglobulin (antibody) structural unit is known to comprise a tetramer. Each tetramer is composed of two identical pairs of polypeptide chains, each pair having one “light” (about 25 kD) and one “heavy” chain (about 50-70 kD). The N-terminus of each chain defines a variable region of about 100 to 110 or more amino acids primarily responsible for antigen recognition. The terms variable light chain (V_{L}) and variable heavy chain (V_{H}) refer to these light and heavy chains respectively.

The term “antibody” as used herein also includes antibody fragments that retain binding specificity and affinity. For example, there are a number of well characterized antibody fragments. Thus, for example, pepsin digests an antibody C-terminal to the disulfide linkages in the hinge region to produce a F(ab′)₂ fragment, a dimer of Fab which itself is a light chain joined to VH-CH1 by a disulfide bond. The F(ab′)₂ may be reduced under mild conditions to break the disulfide linkage in the hinge region thereby converting the F(ab′)₂ dimer into an Fab′ monomer. The Fab′ monomer is essentially an Fab with part of the hinge region (see, Fundamental Immunology, W. E. Paul, ed., Raven Press, N.Y. (1993), for a more detailed description of other antibody fragments). While various antibody fragments are defined in terms of the digestion of an intact antibody, one of skill in the art will appreciate that fragments can be synthesized de novo either chemically or by utilizing recombinant DNA methodology. Thus, the team antibody, as used herein also includes antibody fragments either produced by the modification of whole antibodies or synthesized using recombinant DNA methodologies.

Antibodies include V_{H}-V_{L} dimers, including single chain antibodies (antibodies that exist as a single polypeptide chain), such as single chain Fv antibodies (sFv or scFv) in which a variable heavy and a variable light region are joined together (directly or through a peptide linker) to form a continuous polypeptide. The single chain Fv antibody is a covalently linked V_{H}-V_{L} which may be expressed from a nucleic acid including V_{H}- and V_{L}-encoding sequences either joined directly or joined by a peptide-encoding linker (e.g., Huston, et al. Proc. Nat. Acad. Sci. USA, 85:5879-5883, 1988). In a single chain antibody format, while the V_{H} and V_{L} are connected to each as a single polypeptide chain, the V_{H} and V_{L} domains associate non-covalently. Alternatively, the antibody can be another fragment. Other fragments can also be generated, e.g., using recombinant techniques, as soluble proteins or as fragments obtained from display methods. Antibodies can also include diantibodies, miniantibodies, and heavy chain dimers, such as antibodies from camelids.

As used herein, “V-region” refers to an antibody variable region domain comprising the segments of Framework 1, CDR1, Framework 2, CDR2, and Framework3, including CDR3 and Framework 4, which segments are added to the V-segment as a consequence of rearrangement of the heavy chain and light chain V-region genes during B-cell differentiation.

As used herein, “complementarity-determining region (CDR)” refers to the three hypervariable regions in each chain that interrupt the four “framework” regions established by the light and heavy chain variable regions. The CDRs are primarily responsible for binding to an epitope of an antigen. The CDRs of each chain are typically referred to as CDR1, CDR2, and CDR3, numbered sequentially starting from the N-terminus, and are also typically identified by the chain in which the particular CDR is located. Thus, a V_{H} CDR3 is located in the variable domain of the heavy chain of the antibody in which it is found, whereas a V_{L} CDR1 is the CDR1 from the variable domain of the light chain of the antibody in which it is found.

The sequences of the framework regions of different light or heavy chains are relatively conserved within a species. The framework region of an antibody, that is the combined framework regions of the constituent light and heavy chains, serves to position and align the CDRs in three dimensional space.

The amino acid sequences of the CDRs and framework regions can be determined using various well known definitions in the art, e.g., Kabat, Chothia, international ImMunoGeneTics database (IMGT), and AbM (see, e.g., Johnson et al., supra; Chothia & Lesk, 1987, Canonical structures for the hypervariable regions of immunoglobulins. J. Mol. Biol. 196, 901-917; Chothia C. et al., 1989, Conformations of immunoglobulin hypervariable regions. Nature 342, 877-883; Chothia C. et al., 1992, structural repertoire of the human VH segments J. Mol. Biol. 227, 799-817; Al-Lazikani et al., J. Mol. Biol. 1997, 273(4)). Definitions of antigen combining sites are also described in the following: Ruiz et al., IMGT, the international ImMunoGeneTics database. Nucleic Acids Res., 28, 219-221 (2000); and Lefranc, M.-P. IMGT, the international ImMunoGeneTics database. Nucleic Acids Res. January 1; 29(1):207-9 (2001); MacCallum et al, Antibody-antigen interactions: Contact analysis and binding site topography, J. Mol. Biol., 262 (5), 732-745 (1996); and Martin et al, Proc. Natl Acad. Sci. USA, 86, 9268-9272 (1989); Martin, et al, Methods Enzymol., 203, 121-153, (1991); Pedersen et al, Immunomethods, 1, 126, (1992); and Rees et al, In Sternberg M. J. E. (ed.), Protein Structure Prediction. Oxford University Press, Oxford, 141-172 1996).

“Epitope” as used herein refers to a site on an antigen to which an antibody binds. Epitopes can be formed both from contiguous amino acids or noncontiguous amino acids juxtaposed by tertiary folding of a protein. Epitopes formed from contiguous amino acids are typically retained on exposure to denaturing solvents whereas epitopes formed by tertiary folding are typically lost on treatment with denaturing solvents. An epitope typically includes at least 3, and more usually, at least 5 or 8-10 amino acids in a unique spatial conformation. Methods of determining spatial conformation of epitopes include, for example, x-ray crystallography and 2-dimensional nuclear magnetic resonance. See, e.g., Epitope Mapping Protocols in Methods in Molecular Biology, Vol. 66, Glenn E. Morris, Ed (1996). In the claimed methods, when a library is screened with an epitope of interest, the screening is typically performed with a longer polypeptide, e.g., a protein antigen that includes the epitope of interest. For example, a library may be screened with a peptide, e.g., of 20-25 amino acids, (e.g., when it is desired to obtain an antibody to a linear epitope) that includes the epitope sequence; or may be screened with a large protein antigen that comprises the epitope of interest, e.g., the sequence for which it is desirable to obtain an antibody. The protein antigen may be the protein in which the epitope of interest naturally occurs or may be a heterologous protein, e.g., screening with the epitope of interest may employ the epitope fused to a scaffold polypeptide sequence or other heterologous sequence. The term “screening the library with an epitope of interest” encompasses these various embodiments.

A “complementary variable region” or a “complementary V-region” as used herein refers to a region that can dimerize with a V-region to produce a functional binding fragment that specifically binds to an antigen of interest. A complementary variable region is typically a V_{L} region, where the variable region is a V_{H} region; or is a V_{H} region, where the variable region is a V_{L} region. The complementary variable region often comprises a CDR3 from a reference antibody that binds to the antigen of interest.

The term “V-segment” refers to the region of the V-region (heavy or light chain) that is encoded by a V gene. For example, The V-segment of the heavy chain variable region encodes FR1-CDR1-FR2-CDR2 and FR3. A “D-segment” refers to the region of a V-region that is encoded by a D gene. Similarly, a “J-segment” refers to a region encoded by a J gene. These terms include various modifications, additions, deletions, and somatic mutations that can occur during maturation.

An “exchange cassette” as used herein typically refers to at least one intact CDR adjoined to at least one intact framework region that are together, naturally occurring. An “exchange cassette” also can refer to at least a part of one CDR that is adjoined to at least one framework that are, together, naturally occurring. In other embodiments, an exchange cassette refers to at least one CDR joined to at least a part of one FR that are together, naturally occurring. An “exchange cassette” can also comprise at least one partial CDR adjoined to at least one partial FR that are together, naturally occurring. An “exchange cassette” can also be isolated from a synthetic library in which one or more of the CDRs is mutated. In this case, the CDR prior to mutagenesis and framework region together are naturally occurring. As used herein, a “front” or “front end” cassette contains CDR1 and at least a partial framework region. Accordingly, a “front” cassette has FR1 and CDR1 and may have part or all of FR2. A “middle” cassette as used herein contains CDR2 and at least a partial framework region. Accordingly, a “middle” cassette has CDR2 and FR3 and may have part or all of FR2.

A “partial CDR” or “part of a CDR” or “partial CDR sequence” in the context of this invention refers to a subregion of an intact CDR sequence, e.g., the CDR region outside of the minimal essential binding site, that is present in an exchange cassette. An exchange cassette of this invention can thus have a “partial” CDR. The end result in the hybrid V-region is a hybrid CDR. For example, a CDR2-FR3 exchange cassette includes embodiments in which a subregion of the CDR2 sequence is present in the CDR2-FR3 exchange cassette such that a hybrid V-region resulting from a CDR2-FR3 exchange would have a CDR2 in which part of the CDR2 is from the exchanged cassette and part is from the CDR2 of the reference antibody. A “partial” CDR sequence comprises a subregion of contiguous residues that is at least 20%, typically at least 30%, 40%, 50%, 60%, 70%, 80%, or 90% or more of the intact CDR.

A “minimal essential binding specificity determinant” or “MEBSD” is the region within a CDR sequence, e.g., a CDR3, that is required to retain the binding specificity of the reference antibody when combined with other sequences, typically human sequences, that re-constitute the remainder of a CDR and the rest of the V-region. As appreciated by one of skill in the art, when the reference antibody minimal binding specificity determinant is less than a complete CDR, a complete CDR still results in the anti-hapten antibody expression library, as the remaining CDR residues are incorporated into the construct. For example, where the CDR is CDR3, appropriate oligonucleotides can be designed to incorporate human sequences, e.g., germline J segments, to replace the CDR3 residues that are not part of the MEBSD.

A “partial FR” or “part of a FR” or “partial FR sequence” in the context of this invention refers to a subregion of an intact FR that is present in an exchange cassette. Accordingly, an exchange cassette of the invention can have a “partial FR” such that a hybrid V-region that is generated from an exchange cassette that has a partial FR, has part of its FR sequence from the exchanged cassette and part of the FR from the V-region of the reference antibody. A “partial” FR sequence comprises a subregion of contiguous residues that is at least 20%, typically at least 20%, typically at least 30%, 40%, 50%, 60%, 70%, 80%, or 90% or more of the intact FR.

An “extended cassette” as used herein refers to an exchange cassette that comprises an additional framework region. Thus, here an “extended cassette” is an exchange cassette that has at least one CDR and at least two framework regions that are typically, together, naturally occurring. An “extended cassette” can also be isolated from a synthetic library in which one or more of the CDRs is mutated. In this case, the CDR prior to mutagenesis and framework region together are naturally occurring (i.e., typically not altered by recombinant means).

A “corresponding” exchange cassette refers to a CDR and a framework region that is encoded by a different antibody gene or gene segment (relative to an antibody that is to undergo exchange), but is, in terms of general antibody structure, the same CDR and framework region of the antibody. For example, a CDR1-FR1 exchange cassette is replaced by a “corresponding” CDR1-FR1 cassette that is encoded by a different antibody gene relative to the reference CDR1-FR1. The definition also applies to an exchange cassette having a partial CDR sequence and/or a partial FR region sequence.

A “hybrid V region” refers to a V-region in which at least one exchange cassette has been replaced by a corresponding exchange cassette from a different antibody gene or gene segment.

“Antigen” refers to substances that are capable, under appropriate conditions, of inducing a specific immune response and of reacting with the products of that response, that is, with specific antibodies or specifically sensitized T-lymphocytes, or both. Antigens may be soluble substances, such as toxins and foreign proteins, or particulates, such as bacteria and tissue cells; however, only the portion of the protein or polysaccharide molecule known as the antigenic determinant (epitopes) combines with the antibody or a specific receptor on a lymphocyte. More broadly, the term “antigen” may be used to refer to any substance to which an antibody binds, or for which antibodies are desired, regardless of whether the substance is immunogenic. For such antigens, antibodies may be identified by recombinant methods, independently of any immune response.

The “binding specificity” of an antibody refers to the identity of the antigen to which the antibody binds, preferably to the identity of the epitope to which the antibody binds.

The phrase “specifically (or selectively) binds” to an antibody or “specifically (or selectively) immunoreactive with,” when referring to a protein or peptide, refers to a binding reaction where the antibody binds to the protein of interest. In the context of this invention, the antibody typically binds to the hapten-labelled epitope of interest with an affinity that is at least 2-3-fold better than its affinity for the comparator hapten.

The term “equilibrium dissociation constant (K_{D}) refers to the dissociation rate constant (k_{d}, time⁻¹) divided by the association rate constant (kₐ, time⁻¹, M⁻¹). Equilibrium dissociation constants can be measured using any known method in the art. A “high affinity” antibody in the context of this invention has an affinity better than 500 nM, and often lesser than 50 nM or 10 nM. Thus, in some embodiments, a high affinity antibody has an affinity in the range of 500 nM to 100 pM, or in the range of 50 or 25 nM to 100 pM, or in the range of 50 or 25 nM to 50 pM, or in the range of 50 nM or 25 nM to 1 pM.

The term “increased binding” when comparing binding of an antibody to one molecule, e.g., a hapten-labeled epitope of interest, vs. another molecule, e.g., a comparator hapten, can result from an increase in binding affinity, an increase in the association rate, or a decrease in the dissociation rate. “Increased binding” is typically reflected by a stronger signal when assessing binding, e.g., via an ELISA.

“Chimeric polynucleotide” means that the polynucleotide comprises regions which are wild-type and regions which are mutated. The term also refers to embodiments in which the polynucleotide comprises wild-type regions from one polynucleotide and wild-type regions from another related polynucleotide.

The term “heterologous” when used with reference to portions of a polynucleotide indicates that the nucleic acid comprises two or more subsequences that are not normally found in the same relationship to each other in nature. For instance, the nucleic acid is typically recombinantly produced, having two or more sequences, e.g., from unrelated genes arranged to make a new functional nucleic acid. Similarly, a “heterologous” polypeptide or protein refers to two or more subsequences that are not found in the same relationship to each other in nature.

“Expression vector” includes vectors which are capable of expressing nucleic acid sequences contained therein, i.e., any nucleic acid sequence which is capable of effecting expression of a specified nucleic acid code disposed therein (the coding sequences are operably linked to other sequences capable of effecting their expression). Some expression vectors are replicable in the host organism either as episomes or as an integral part of the chromosomal DNA. A useful, but not a necessary, element of an effective expression vector is a marker encoding sequence—i.e. a sequence encoding a protein which results in a phenotypic property (e.g. tetracycline resistance) of the cells containing the protein which permits those cells to be readily identified. Expression vectors are frequently in the form of plasmids or viruses. However, the invention is intended to include such other forms of expression vectors which serve equivalent functions and which may, from time to time become known in the art.

“Host cell” refers to a prokaryotic or eukaryotic cell into which the vectors of the invention may be introduced, expressed and/or propagated. A microbial host cell is a cell of a prokaryotic or eukaryotic micro-organism, including bacteria, yeasts, microscopic fungi and microscopic phases in the life-cycle of fungi and slime molds. Typical prokaryotic host cells include various strains of E. coli. Typical eukaryotic host cells are yeast or filamentous fungi, insect cells, or mammalian cells, such as Chinese hamster ovary cells, murine NIH 3T3 fibroblasts, human embryonic kidney 193 cells, or rodent myeloma or hybridoma cells.

“Isolated” refers to a nucleic acid or polypeptide separated not only from other nucleic acids or polypeptides that are present in the natural source of the nucleic acid or polypeptide, but also from polypeptides, and preferably refers to a nucleic acid or polypeptide found in the presence of (if anything) only a solvent, buffer, ion, or other component normally present in a solution of the same. The terms “isolated” and “purified” do not encompass nucleic acids or polypeptides present in their natural source.

“Purified” means that the indicated nucleic acid or polypeptide is present in the substantial absence of other biological macromolecules, e.g., polynucleotides, proteins, and the like. In one embodiment, the polynucleotide or polypeptide is purified such that it constitutes at least 95% by weight, more preferably at least 99.8% by weight, of the indicated biological macromolecules present (but water, buffers, and other small molecules, especially molecules having a molecular weight of less than 1000 daltons, can be present).

“Recombinant” as it relates to a nucleic acid refers to a nucleic acid in a foam not normally found in nature. That is, a recombinant nucleic acid is flanked by a nucleotide sequence not naturally flanking the nucleic acid or has a sequence not normally found in nature. Recombinant nucleic acids can be originally formed in vitro by the manipulation of nucleic acid by restriction endonucleases, or alternatively using such techniques as polymerase chain reaction. It is understood that once a recombinant nucleic acid is made and reintroduced into a host cell or organism, it will replicate non-recombinantly, i.e., using the in vivo cellular machinery of the host cell rather than in vitro manipulations; however, such nucleic acids, once produced recombinantly, although subsequently replicated non-recombinantly, are still considered recombinant for the purposes of the invention.

“Recombinant” polypeptide refers to a polypeptide expressed from a recombinant nucleic acid, or a polypeptide that is chemically synthesized in vitro.

Preferably, amino acid “substitutions” are the result of replacing one amino acid with another amino acid having similar structural and/or chemical properties, i.e., conservative amino acid replacements. Amino acid substitutions may be made on the basis of similarity in polarity, charge, solubility, hydrophobicity, hydrophilicity, and/or the amphipathic nature of the residues involved. For example, nonpolar (hydrophobic) amino acids include alanine, leucine, isoleucine, valine, proline, phenylalanine, tryptophan, and methionine; polar neutral amino acids include glycine, serine, threonine, cysteine, tyrosine, asparagine, and glutamine; positively charged (basic) amino acids include arginine, lysine, and histidine; and negatively charged (acidic) amino acids include aspartic acid and glutamic acid.

“Insertions” or “deletions” are typically in the range of about 1 to 5 amino acids. The variation allowed may be experimentally determined by systematically making insertions, deletions, or substitutions of amino acids in a polypeptide molecule using recombinant DNA techniques and assaying the resulting recombinant variants for activity.

Alternatively, where alteration of function is desired, insertions, deletions or non-conservative alterations can be engineered to produce altered polypeptides. Such alterations can, for example, alter one or more of the biological functions or biochemical characteristics of the polypeptides of the invention. For example, such alterations may change polypeptide characteristics such as ligand-binding affinities, interchain affinities, or degradation/turnover rate. Further, such alterations can be selected so as to generate polypeptides that are better suited for expression, scale up and the like in the host cells chosen for expression. For example, cysteine residues can be deleted or substituted with another amino acid residue in order to eliminate disulfide bridges.

Recombinant variants encoding the same polypeptides as an indicated amino acid sequence may be synthesized or selected by making use of the “redundancy” in the genetic code. Various codon substitutions, such as the silent changes which produce various restriction sites, may be introduced to optimize cloning into a plasmid or viral vector or expression in a particular prokaryotic or eukaryotic system. Mutations in the polynucleotide sequence may be reflected in the polypeptide or domains of other peptides added to the polypeptide to modify the properties of any part of the polypeptide, to change characteristics such as ligand-binding affinities, interchain affinities, or degradation/turnover rate.

In the general context of this invention, the ten “a” or “an” is intended to mean “one or more”.

### DETAILED DESCRIPTION OF THE INVENTION

### Introduction

The invention provides an in vitro method of obtaining monoclonal antibodies that bind to a predetermined epitope of an antigen of interest. The method is not constrained by tolerization or self antigen recognition.

The methods of the invention include screening an anti-hapten library where the anti-hapten focused library is derived from a reference antibody to a hapten. An anti-hapten focused library can be constructed, for example, in which the antibody members of the library retain a minimal essential binding specificity determinant (MEBSD) from at least one heavy and light chain CDR from the reference antibody other parts of the antibody are diversified. The library can then be screened with the epitope of interest labeled with the hapten. Positive clones obtained from the screen that bind to the hapten-labeled epitope can further be screened with the unlabeled epitope to identify those that having binding activity for the unlabeled epitope. One or more screening cycles can be performed. In some embodiments, the residues in the MEBSD from the reference antibody that are critical to hapten binding may be removed.

In some embodiments, an antibody to an epitope of interest is obtained using an anti-hapten focused library where the reference antibody that is used to create the anti-hapten focused library is an antibody to a modified amino acid. Such a hapten may be a modified amino acid that occurs naturally in proteins as a consequence of post-translational modification such as phosphotyrosine, phosphoserine, phosphothreonine, sulphotyrosine, N-formyl methionine, biotinyl lysine or an acetylated amino acid or an amidated amino acid. Alternatively, the hapten may be a non-natural amino acid such as p-nitro phenylalanine, nitro tyrosine or iodotyrosine.

Examples of many different haptens and known antibodies that bind to those haptens can be found, e.g., in the SuperHapten database, supra, and HaptenDB, supra.

Any number of anti-hapten reference antibodies may be used to construct an anti-hapten focused library. Typically, a reference antibody is chosen that binds to a hapten with minimal influence of the surrounding amino acid context. A reference antibody typically has an affinity of better than about 100 nM, e.g., 50-100 nM and a rapid off-rate (kd), for example, an off-rate faster than 10⁻³/s or more preferably at least 5×10⁻³/s. A suitable reference antibody typically has at least two, often at least three, and preferably four, CDRs that can be changed and still retain hapten binding specificity.

### Anti-Hapten Libraries

This section describes construction of anti-hapten libraries and screening with a hapten-labeled epitope of interest. It focuses on the construction of anti-phosphotyrosine libraries as an example and screening with phosphotyrosine-labeled epitopes of interest; however, the methodology can be employed for screening any anti-hapten focused library with a hapten-labeled epitope or for constructing any anti-hapten focused library.

In order to practice the invention, an anti-hapten antibody is selected and is used to construct an anti-hapten library. Recombinant antibodies derived from the library are then selected, based on (i) ability to bind the hapten, and (ii) ability to bind the hapten-labeled epitope of interest. Those antibodies that exhibit increased binding to the hapten-labeled epitope of interest compared to binding to the hapten alone can then be used to construct libraries for additional rounds of screening until an antibody that has the desired binding properties for the epitope of interest is obtained.

Once an antibody that binds to an epitope of interest is identified in an anti-hapten focused library, the antibody can be subjected to additional rounds of epitope focusing, e.g., additional rounds of cassette exchange, chain replacement, CDR shuffling, CDR mutagenesis and the like to obtain an antibody that retains the binding specificity for the epitope of interest that the selected antibody from the anti-hapten focused library has, but binds to the epitope of interest with an improved affinity (lower dissociation constant) in comparison to the starting antibody selected from the anti-hapten focused library.

An anti-hapten focused library can be obtained using a variety of methods. As understood in the art, the methods described below relating to preparation of an anti-hapten focused library can also be used after the initial screening of the anti-hapten focused library to construct sub-libraries for screening for improved binding characteristics for the epitope of interest.

Further, as additionally explained below, the anti-hapten focused library can be any type of library used to screen antibodies, e.g., a display library such as a phage or bacterial surface display library, or a library where the antibody is secreted.

Anti-hapten libraries may be constructed from a reference anti-hapten antibody using any method known in the art. In generating the anti-hapten focused library, the members of the library retain at least one minimal essential binding specificity determination (MEBSD) from a CDR from the heavy chain and/or at least one MEBSD from a CDR from the light chain of the reference antibody. In typical embodiments, the anti-hapten libraries retain at least one MEBSD from a CDR from the heavy chain of the reference antibody and at least one MEBSD from the light chain of the reference antibody. The anti-hapten focused library may retain additional CDR and/or framework sequences from the reference antibody, e.g., the anti-hapten focused library may comprise a heavy and/or light chain CDR3-FR4 from the reference antibody.

In generating the anti-hapten focused library, portions of the V_{H} and V_{L} sequences of the reference antibody are replaced with sequences from another antibody repertoire to generate an anti-hapten focused library having a diversity of sequences. The sequences introduced into the library are typically from a human repertoire.

The reference antibody may be a non-human antibody, e.g., a murine antibody, or can be from any other species.

As noted above, the MEBSD is the region within a CDR sequence, e.g., a CDR3, that is required to retain the binding specificity of the reference antibody when combined with other sequences, typically human sequences, that re-constitute the remainder of CDR and the rest of the V-region.

The MEBSD can be identified as known in the art (see, e.g., US patent application publication no. 20050255552). In brief, the MEBSD can be defined empirically or can be predicted from structural considerations. For empirical determination, methods such as alanine scanning mutagenesis can be performed on the CDR, e.g., a CDR3, region of a reference antibody (Wells, Proc. Natl. Acad. Sci. USA 93:1-6, 1996) in order to identify residues that play a role in binding to antigen. Additional analyses can include Comprehensive Scanning Mutagenesis, in which each residue of a CDR is replaced, one-at-a-time, with each of the 19 alternative amino acids, rather than just replacement with alanine. Binding assays such as colony-lift binding assays, can be used to screen libraries of such mutants to determine those mutants that retain binding specificity. Colonies that secrete antibody fragments with assay signals reduced by at least ten-fold relative to the reference antibody can be sequenced and the DNA sequences used to generate a database of amino acid positions in the CDR that are important for retention of binding. The MEBSD can then be defined as the set of residues that do not tolerate single-site substitution, or which tolerate only conservative amino acid substitution.

An MEBSD can also be determined by deletion analysis in which progressively shorter sequences of a reference antibody CDR are evaluated for the ability to confer binding specificity and affinity. For example, where the CDR is a CDR3, this can be accomplished by substituting the CDR3 residues with progressively longer human sequences, e.g., from a human germline J segment.

The MEBSD can also be deduced from structural considerations. For example, if the x-ray crystal structure is known, or if a model of the interaction of antibody and antigen is available, the MEBSD may be defined from the amino acids required to form suitable contact with the epitope and to retain the structure of the antigen-binding surface. In some cases, the MEBSD can also be predicted from the primary structure. For example, in V_{H} domains, for instance, the MEBSD of the CDR3 can, in some antibodies, correspond to a D-segment (including any deletions or identifiable N-additions resulting from the re-arrangement and maturation of the reference antibody). Further, software programs such as JOINSOLVER® Souto-Carneiro, et al., J. Immunol. 172 :6790-6802, 2004) can be used to analyze CDR3 of immunoglobulin gene to search for D germline sequences.

In some embodiments, an anti-hapten focused library is generated using cassette exchange. The V-gene segment of both the heavy and light chain can be regarded as being comprised of a number of cassettes formed by framework and CDR segments. Thus, the V_{H} and V_{L}-gene segments are each comprised of five “minimal cassettes” (CDR1, CDR2, FR1, FR2, and FR3). The V-regions may additionally be considered to be composed of “exchange cassettes” comprised of two or more minimal cassettes where the exchange cassette includes at least one CDR and at least one FR joined in natural order. Thus, for example, an exchange cassette relating to CDR1 may consist of FR1-CDR1 or FR1-CDR1-FR2. There are nine such exchange cassettes in each V-gene segment, consisting of at least one framework and one CDR (and less than three frameworks) in the appropriate order. The complete V-region includes two additional minimal cassettes, CDR3 and FR4. CDR3-related exchange cassettes include CDR3-FR4 or FR3-CDR-3-FR4.

In some embodiments, the anti-hapten focused library is generated by replacing exchange cassettes of the reference anti-hapten antibody with a corresponding exchange cassette, e.g., from a repertoire of human antibody sequences.

The methods comprising replacing an exchange cassette of a variable region of an anti-hapten reference antibody with a corresponding exchange cassette from an antibody that is encoded by a different gene can be performed sequentially or concurrently. Thus, in some embodiments, one or more members of an anti-hapten focused library in which one exchange cassette has been replaced by a corresponding library of sequences from other antibody genes can be selected for binding to the hapten-labeled epitope (or the epitope of interest) (thus providing a sub-library) and the sub-library can be subjected to further rounds of replacing cassettes or otherwise manipulated.

Libraries are typically generated using cloned cassettes of reference antibody sequences and repertoires of human immunoglobulin-derived sequences. The human repertoires can be generated by PCR amplification using primers appropriate for the desired segments from cDNA obtained from peripheral blood or spleen, in which case the repertoires are expected to contain clones with somatic mutations. Alternatively, the repertoires can be obtained by amplification of genomic DNA from non-immune system cells in order to obtain non-mutated, germline-encoded sequences.

An exchange cassette typically has at least one framework and one CDR linked in a natural order and has no more than two frameworks and two CDRs. Examples of exchange cassettes that are often used include:

FR1-CDR1

FR1-CDR1-FR2

FR2-CDR2-FR3

CDR2-FR3, or

FR3-CDR3.

The complete V-region has two additional minimal cassettes (CDR3 and FR4) not present in the V-gene segment. Where desired, these additional cassettes from a reference hapten antibody can also be substituted by sequences from a library of human antibody sequences such that a V-region is generated from entirely human sequences while retaining the antigen binding specificity of the reference antibody.

In some embodiments, a CDR in an exchange cassette is a hybrid CDR. A “hybrid CDR” in the context of this invention refers to a CDR that comprises an MEBSD from a reference antibody and additional sequence in the CDR that is different from the CDR sequence of the reference antibody. The MEBSD sub-sequence can be at any position within the CDR and typically comprises one to several amino acids. A CDR cassette can be constructed using any of the six CDRs contained within V_{H} and V_{L}.

Methods for obtaining diverse antibody libraries suitable for use in the present invention to select high-affinity antibodies are known in the art. For example, in the chain-shuffling technique (Marks, et al., Biotechnology 10:779-83, 1992) one chain of an antibody is combined with a naive human repertoire of the other chain. Chain shuffling can be used to screen diverse sequences for one of the antibody chains while retaining an MEBSD present in the other chain.

Similarly, methods for diversifying one or more CDRs may be used, such as libraries of germline CDRs recombined into a single framework (Soderlind et al., Nature Biotech. 18:852, 2000) or randomized CDRs inserted in consensus frameworks (Knappik et al., J. Mol. Biol. 296:57-86, 2000).

In some embodiments, the anti-hapten focused library has a diversity of no larger than about 10⁸ recombinants, e.g., about 10⁷, about 10⁶, about 10⁵, about 10⁴, about 10³ recombinants or fewer. Typically, the number of clones screened is no more than about 10⁵ and is often in the range of about 10³ to about 10⁴ or to about 10⁵.

In other embodiments, e.g., in embodiments in which an anti-hapten focused library is screened with an unlabeled epitope of interest without having previously being screened with the hapten-labeled epitope, the library is larger, e.g., the library has a diversity of greater than about 10⁹ recombinants, e.g., about 10¹⁹, about 10¹¹, or about 10¹² recombinants.

### Phospho-Amino Acid-Based Anti-Hapten Libraries

In some embodiments, the anti-hapten focused library that is screened in accordance with the invention is constructed using an anti-phosphotyrosine antibody. Antibodies that selectively bind to phosphotyrosine residues are known in the literature (see, e.g., Ruff-Jamison et al 1991, Ruff-Jamison and Glenney 1993). Examples include 4G10 (Millipore), Mab1676 (R&D Systems), 3G239 (Genway), P-Tyr-100 and P-Tyr-102 (Cell Signaling Technology Inc; U.S. Pat. No. 6,441,140), PT-66 (Sigma-Alldrich), 13F9 (Cayman Chemical Inc), 2C8 (Nanotools Inc), SPM102 (Thermo Scientific), 6D12 (Enzo Life Sciences), 13F9 (Genetex), PY99 (Molecular Probes Inc.). Methods for generating antibodies to phosphotyrosine are also well known in the art and are described, for example, in U.S. Pat. No. 6,441,140. Such antibodies can be employed as a reference antibody to generate the anti-hapten focused library. Anti-phosphotyrosine antibodies that are typically used do not bind to non-phosphorylated proteins/peptides. Some antibodies may bind broadly to phosphotyrosine residues in different peptide sequences whereas other antibodies bind to phosphotyrosine residues but have some peptide sequence specificity (Kanner et al 1990, Mandell et al 2003). The specificity of phosphotyrosine selective reference antibodies can be modified so that antibodies can be generated starting from the reference antibody that bind selectively to the non-phosphorylated peptide/protein at the site initially tagged by the phosphotyrosine.

Any epitope of interest may be labeled with a phosphotyrosine and used to screen such a library. A naturally occurring tyrosine amino acid can be modified by the addition of a phosphate group. In some embodiments, an epitope of interest can be modified (or tagged) by incorporation of a tyrosine residue at a chosen position in the peptide or protein followed by phosphorylation of the added tyrosine to generate a site specific phosphotyrosine residue. In some embodiments where the epitope is prepared by chemical synthesis, e.g., the synthesis of a small peptide, a phosphotyrosine can be incorporated during synthesis at either the position of a naturally occurring tyrosine in the epitope of interest or at another position. In some embodiments, a tyrosine is phosphorylated using a tyrosine kinase or other kinase.

In other embodiments, the anti-hapten focused library that is screened in accordance with the invention is constructed using an anti-phosphoserine or anti-phosphothreonine antibody. See, e.g., U.S. Pat. No. 7,723,069 for methods for incorporating phosphoserine into protein or peptide antigens. Additional methods of synthesizing peptides that incorporate phosphoserine or phosphothreonine are described by Arendt et al., Int. J. Peptide Prot. Res. 33:468-476, 1989; and Arendt and Hargrove, Meth. Mol. Biol. Vol 35, Chapter 9, 187-193, 1994. Various mouse monoclonal antibodies directed against phosphoserine and phosphothreonine are commercially available. Antibodies directed against phosphoserine include PSR-45 (Sigma), PS-53 (Novus Biologicals), 106.1 (ThermoPierce), 3C171 (ThermoPierce), 9A354 (US Biological), 6D664 (US Biological) and 11C149 (US Biological). Antibodies directed against phosphothreonine include PTR-8 (Sigma), 5H19 (US Biological), 11C156 (US Biological) and 9A355 (US Biological).

### Antibody Libraries

Antibodies can be expressed using any number of known vectors and expression systems. “Vector” refers to a plasmid or phage or virus or vector, for expressing a polypeptide from a DNA (RNA) sequence. The vector can comprise a transcriptional unit comprising an assembly of (1) a genetic element or elements having a regulatory role in gene expression, for example, promoters or enhancers, (2) a structural or coding sequence which is transcribed into mRNA and translated into protein, and (3) appropriate translation initiation and termination sequences. Structural units intended for use in yeast or eukaryotic expression systems may include a leader sequence enabling extra-cellular secretion of translated protein by a host cell.

Libraries of secreted antibodies or antibody fragments can be expressed in prokaryotic or eukaryotic microbial systems or in the cells of higher eukaryotes such as mammalian cells. The antibody library can be a library where the antibody is an IgG, an Fv, an Fab, an Fab′, an F(ab′)₂, a single chain Fv, an IgG with a deletion of one more domains, or any other antibody fragment that includes the V-region.

The antibodies can be displayed on the surface of a virus, cell, spore, virus-like particle, or on a ribosome. For this purpose, one or both chains of the antibody fragment are typically expressed as a fusion protein, for example as a fusion to a phage coat protein for display on the surface of filamentous phage. Alternatively, the antibodies of the antibody library can be secreted from a host cell.

Antibody-expressing host cells or phage are selected by screening with a protein in order to isolate clones expressing antibodies of interest.

In some embodiments, the antibody libraries described herein are expressed as soluble antibodies or antibody fragments and secreted from host cells. For example, the libraries can be expressed by secretion from E. coli or yeast and colonies of cells expressing antigen-binders are revealed by a colony-lift binding assay. Any suitable host cell can be used. Such cells include both prokaryotic and eukaryotic cells, e.g., bacteria, yeast, or mammalian cells.

### Library Screening

### Hapten-Labeled Epitope for Screening

An anti-hapten focused library generated using any of the methods described above is screened with the epitope of interest labeled with the hapten. Screening may employ the epitope of interest as a peptide, e.g., of 15-25 or more amino acids in length that corresponds to the region of an antigen for which it is desired to obtain an antibody; or as a protein, where the epitope of interest is present in a large protein and the library is screened with the antigen that contains the epitope. In embodiments in which the epitope of interest used for screening is present in a large protein antigen, the epitope of interest is labeled with the hapten. In embodiments in which the epitope of interest is used in screening as part of a larger protein, the larger protein need not be the native protein in which the epitope of interest is present. The epitope may be fused to a heterologous amino acid sequence and used for screening.

The hapten label can be attached to the epitope using any method known in the art. For example, where the anti-hapten antibody library is generated using a reference antibody to phosphotyrosine, the hapten-labeled epitope used for screening is labeled with a phosphotyrosine. In some embodiments, a tyrosine present in the epitope interest is labeled by phosphorylation using a kinase such as a tyrosine kinase. In embodiments in which a tyrosine does not naturally occur in the epitope of interest, a tyrosine may be introduced into the sequence, e.g., when chemically synthesizing a peptide or by site-directed mutagenesis when expressing a protein comprising the epitope, and subsequently labeled phosphorylated. Further, e.g., when chemically synthesizing a small peptide epitope of interest, the phosphotyrosine can be directly incorporated during the chemical synthesis reaction. Examples of tyrosine kinases suitable for use in the invention include non-receptor tyrosine kinases such as src family tyrosine kinases (Src, Yes, Fyn, Fgr, Lck, Hck, Blk, Lyn and Frk) and receptor tyrosine kinases for which approximately 20 classes are described including EGF-receptor family, Insulin receptor family, PDGF-receptor family, FGF-receptor family, VEGF-receptor family, HGF-receptor family, Trk-receptor family, Eph-receptor family, AXL-receptor family, LTK-receptor family, TIE-receptor family, ROR-receptor family, DDR-receptor family, RET-receptor family, KLG-receptor family, RYK-receptor family and MuSK-receptor family.

In embodiments in which the reference antibody used to generated the anti-hapten focused library binds phosphoserine and/or phosphothreonine, a serine or threonine present in the epitope of interest can be phosphorylated, e.g., using a serine/threonine specific kinase, to be used in screening. Again, the serine or threonine may naturally occur in the epitope of interest or may be introduced. As noted above, phosphoserine can be introduced into a polypeptide using known techniques, such as that described in U.S. Pat. No. 7,723,069. Additional methods of synthesizing peptides that incorporate phosphoserine or phosphothreonine are described by Arendt et al., Int. J. Peptide Prot. Res. 33:468-476, 1989; and Arendt and Hargrove, Meth. Mol. Biol. Vol 35, Chapter 9, 187-193, 1994.

Similarly, in embodiments in which the reference anti-hapten antibody binds to a sulphated tyrosine hapten, a tyrosine, either naturally occurring or introduced, in the epitope of interest can be generated using tyrosylprotein sulphotransferase. Tyrosylprotein sulphotransferases are known in the art. For example human tyrosylprotein sulphotransferase 1/TPST1 has been isolated and the gene cloned and expressed (Ouyang et al., Proc. Natl. Acad. Sci USA 95:2896-2901, 1998). Recombinant human TPST1 is commercially available (R&D Systems Inc).

Alternatively, the hapten may be a non-natural amino acid such as p-nitro phenylalanine, nitro tyrosine or iodotyrosine.

In other embodiments, e.g., where a hapten is a small molecular weight compound such as a nonnaturally occurring modified amino acid, e.g., nitrotyrosine or iodotyrosine; dinitrophenyl; biotin; fluoroscein; digoxigenin; and the like, the hapten may be linked to the epitope of interest using known methodology such as by chemical linkage. Chemical linkages to link a hapten to an epitope of interest are described, e.g., in the HaptenDB database, supra.

In some embodiments, screening with hapten-labeled epitope is performed in the presence of comparator hapten. In such embodiments, the comparator hapten is provided linked to a carrier protein such as albumin, keyhole limpet antigen, or a nonprotein carrier.

### Screening

Screening can be performed using an number of known techniques as described above. The following section provides an example of library screening using a microbial expression system.

Filter screening methodologies have been described for detection of secreted antibodies specific for a particular antigen. In one format, the secreted antibody fragments are trapped on a membrane which is probed with soluble antigen (Skerra et al (1991) Anal Biochem. 196:151-5). In this case, bacteria harboring plasmid vectors that direct the secretion of Fab fragments into the bacterial periplasm are grown on a membrane or filter. The secreted fragments are allowed to diffuse to a second “capture” membrane coated with antibody which can bind the antibody fragments (eg anti-immunoglobulin antiserum) and the capture filter is probed with specific antigen. Antibody—enzyme conjugates can be used to detect antigen-binding antibody fragments on the capture membrane as a colored spot. The colonies are re-grown on the first membrane and the clone expressing the desired antibody fragment recovered.

Colony lift binding assays have also been described in which the antibodies are allowed to diffuse directly onto an antigen-coated membrane. Giovannoni et al have described such a protocol for the screening of single-chain antibody libraries (Giovannoni et al., Nucleic Acids Research 2001, Vol. 29, No. 5 e27).

Libraries of secreted antibody fragments can also be screened by ELISA, either using pools of multiple clones or screening of individual clones each secreting a unique antibody sequence. One such method for screening individual clones is described by Watkins et al (1997) Anal. Biochem. 253: 37-45. In this case, microtiter wells were coated with anti-Fab antibody to capture Fab fragments secreted directly in the wells. The Fab samples were then probed with soluble biotinylated antigen followed by detection with streptavidin-alkaline phosphatase conjugates.

Following selection of an antibody from the anti-hapten focused library that binds to the epitope of interest, V-regions from the selected antibody may be subjected to additional rounds of diversification, e.g., by exchange cassette, CDR mutagenesis, chain replacement and the like to improve binding to the epitope of interest. For example, the V-segments, or one or more exchange cassettes within the V-segments of the selected antibody can be replaced with a diversity of the corresponding V-segment or exchange cassette. Further, the selected antibody can be subjected to mutagenesis of one or more CDRs, to identify variants (or the selected antibody) that bind to the epitope of interest.

As explained above, display libraries can also be employed. Such libraries are screened using known techniques. For example, positive clones may be selected using immobilized epitope, e.g., hapten-labeled epitope.

### Additional Screening Methods

The invention also provides methods in which an anti-hapten focused library is screened with an unlabeled epitope of interest without prior screening to identify clones that bind to hapten-labeled epitope. This method is typically performed when the epitope of interest is not a linear epitope. The anti-hapten focused library is therefore preferably screened with the antigen that comprises the epitope of interest, or an appropriate subregion of the antigen of interest.

In embodiments of this screening method, the anti-hapten focused library is screened with the antigen comprising the epitope without hapten-labelling the epitope. Clones that bind the unlabelled antigen are also screened with the hapten-labeled epitope. Preferably, the hapten-labeled epitope is the antigen, or appropriate subregion, comprising the epitope where the hapten is linked to the epitope of interest. Those clones that bind better to hapten-labeled antigen compared to binding to the antigen that is not labeled with hapten are then selected. The selected clones may be subjected to additional diversification, i.e., one or more additional rounds of screening in which an antibody is selected and regions of the selected antibody are replaced (while retaining the binding specificity of the selected antibody) to generate further libraries for screening.

The anti-hapten focused libraries employed in the methods of the invention that comprise screening with the antigen without hapten labelling without prior screening with hapten-labeled epitope typically have a diversity of greater than about 10⁹ recombinants.

The following examples are provided by way of illustration only and not by way of limitation. Those of skill in the art will readily recognize a variety of non-critical parameters that could be changed or modified to yield essentially similar results.

### EXAMPLES

### Example 1

### Characterization of V-Region Amino Acid Residues Necessary for Phoshotyrosine Binding in Antibody PY20

Tables 1-7 described in the examples below are provided immediately before the claims.

Antibody PY20 (Ruff-Jamison et al., J. Biol. Chem. 266:6607-6613, 1991) is a mouse monoclonal antibody which binds to phosphotyrosine. PY20 will also bind PTyr when the amino acid is incorporated into peptides or proteins having diverse sequences. Thus, PY20 binds strongly to PTyr independent of the surrounding amino acid context

The CDR regions of PY20 are indicated in bold in the following schematics. The shaded residues (also indicated in larger font) are important for phosphotyrosine binding.

PY20 light chain V-region
DVQMTQTTS SLSASLGDRV TISCSASQGI SNYLNWYQQK
PDGTVKLLIY YTSSLHSGVP SRFSGSGSGT DYSLTISNLE
PEDFATYYCQ QYSKVP [symbol] TFG GGTKLEIK
PY20 heavy chain V-region
QVQLQQSGP ELVKPGASVK ISCKTSGYTF TEYTM [symbol] WMKQ
SHGKSLEWMG GINPNSGGT [symbol] DNQRFKGKAT LTVDKSSSIA
YMELRSLTSE DSAVYYCAR [symbol] GPYGNYANS [symbol] [symbol] WGQGTT
VTVSS

Important amino acid residues for phosphotyrosine (PTyr) binding are distributed across four of the six PY20 CDRs. Diverse, human PTyr binding libraries were prepared in which important amino acids are either present in the human CDRs or are engineered into all CDRs of the library. Thus, CDRs can be changed in order to retain PTyr binding, but add new antibody-antigen contacts in order to add specificity and affinity. V-region constructions and screening for new antigen contacts was performed as follows.

### Construction of Diverse, Humaneered Libraries of Phophotyrosine Binding Antibodies

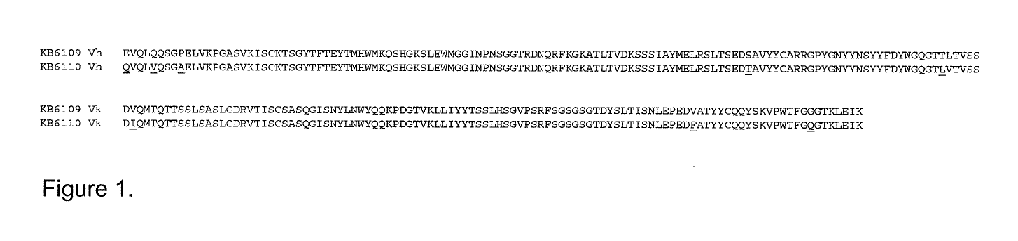

The light and heavy chain V-regions from PY20 were cloned into Fab expression vectors containing human constant regions; PY20 has a kappa light chain. For Fab expression in E. coli, the heavy and light chain translation units are not preceded by a signal peptide, but are secreted into the periplasm by the co-expression of a SecY^{mut} gene; the signal-less secretion system has been described in US patent application publication no. 20070020685. The reference (chimeric) Fab was named KB6109. An optimized reference Fab was also constructed in which regions in FR1, FR3 and FR4 of the heavy and light chains were changed to human germ-line residues. The sequences of the reference and optimized reference V-regions are shown in FIG. 1. The Fab expression plasmids KB6109 and KB6110 were transformed into the E. coli strain TOP10 along with plasmid KB5282, which expresses the SecY^{mut} gene. The KB6109 and KB6110 Fabs were expressed and secreted into the periplasm; the secreted Fab is purified by Protein G chromatography.

In order to increase the affinity of PY20 binding to PTyr and to determine the CDR3 minimal essential binding specificity determinant regions, the HCDR3 and LCDR3 were affinity matured. Degenerate codons were introduced into the HCDR3 and the LCDR3 to construct libraries where each variant differed from the reference CDR3 at only one position. The heavy and light chain CDR3 libraries were appended to the reference and optimized reference V-segments and a library was constructed in which the LCDR3 and HCDR3 variants were randomly mixed. The resulting CDR3 library was expressed in E. coli and screened with a colony lift binding assay (CLBA) for Fabs binding to phosphotyrosine-conjugated BSA (PTyr-BSA). Many positive clones were detected and several were chosen for ELISA and kinetic analysis. Table 1 summarizes the CDR3 sequences and the affinity measurements for the highest affinity clones. The 3P1C Fab had an improved off-rate versus the reference Fab KB6109. The 3P1C HCDR3 and LCDR3 sequences were chosen for the PTyr-binding BSD regions along with a human germ-line FR4 (from JH4 for the heavy chain CDR3 BSD and from Jk2 for the light chain CDR3 BSD). A reference Fab, PY207-1, was constructed with the PY20 reference V-segments and the 3P1C CDR3 BSD/FR4 regions.

Humaneering libraries have been described in US patent application publication no. 20050255552. Briefly, the CDR3 BSD region from a reference antibody (typically along with a human germ-line FR4) is appended to a diverse human V-segment library. The resulting library is focused on the same epitope as the reference antibody. The HCDR3 BSD/FR4 region for the heavy chain was appended to a Vh-segment library derived from human spleen. The Vh-segment library contained representatives from all seven human germ-line heavy chain subclasses. The LCDR3 BSD/FR4 region for the light chain was appended to a Vk-segment library derived from human spleen. The Vk-segment library contained representatives from all six human germ-line kappa chain subclasses. The resulting V-regions were cloned into a Fab expression vector with the complementary reference and optimized reference chains.

In addition to full V-segment libraries, hybrid cassette libraries were constructed. Cassette construction has been described in US patent application publication no. 20060134098. Briefly, a cassette is a CDR region along with one or more full or partial flanking human FR regions. For example, a ‘front’ cassette contains a human FR1, CDR1 and a full or partial FR2. A ‘middle’ cassette contains a full or partial human FR2, CDR2 and FR3. A CDR3/FR4 cassette contains the CDR3 and a full or partial FR4. In each case, the ‘front’ or ‘middle’ cassette is joined with the complementary cassette and the CDR3 BSD/FR4 cassette. Cassettes can be a single sequence or a diverse library of sequences. Cassettes are fused together using overlap extension PCR or ligation. The resulting cassette libraries were cloned into Fab expression vectors with the complementary reference and optimized reference chains.

In addition to cassette libraries, an HCDR2 diversity library was constructed by replacing some reference HCDR2 amino acids with one or more cognate amino acids from the human germ-line Vh1 subclass HCDR2 sequences. The HCDR2 diversity library was made by synthesizing oligomers with degenerate nucleic acid sequence so that all HCDR2 amino acid combinations are represented in the library. The HCDR2 library was joined with the appropriate flanking cassettes by overlap extension PCR.

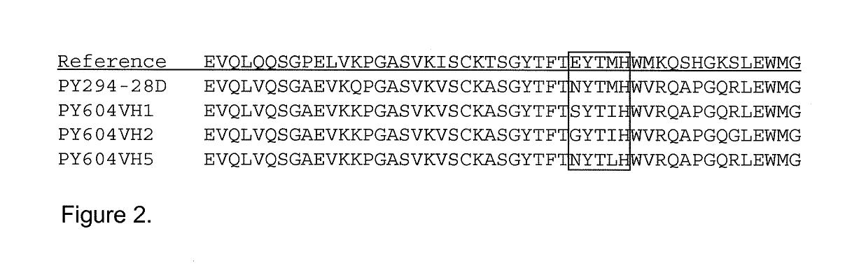

The human cassette libraries were constructed with the complementary regions from the reference or optimized reference chains. The full chain and cassette Fab libraries were screened for binding to PTyr-BSA by the colony lift binding assay. The results of the CLBA screens are shown in Table 3. No binders were identified with the heavy chain full chain or middle cassette libraries. Several heavy chain ‘front’ cassettes were identified, indicating that diverse human CDR1 and adjacent FR sequences can support PTyr-BSA binding; representative heavy chain ‘front’ cassette sequences are shown in FIG. 2. All of the heavy chain front cassettes were from the human Vh1 subclass.

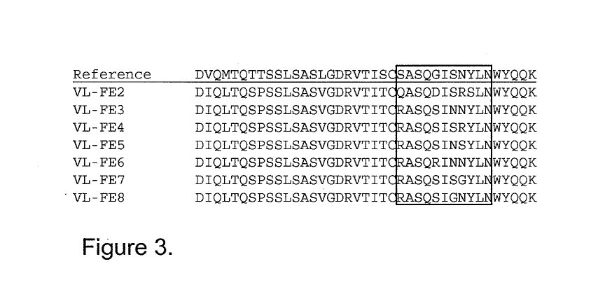

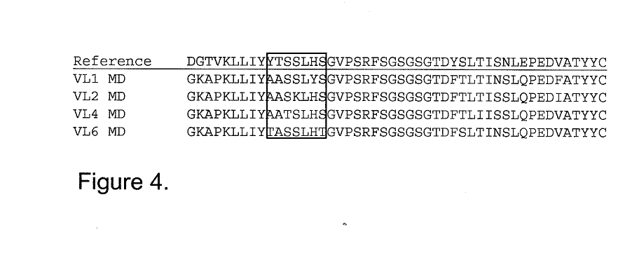

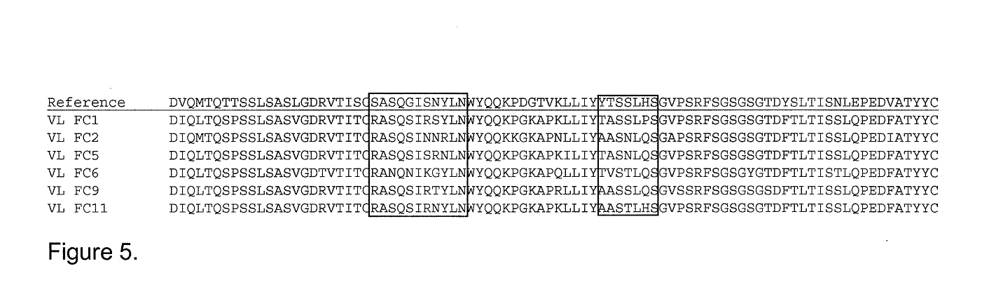

In contrast to the heavy chain, many different light chain front and middle cassette sequences could support Fab binding to PTyr-BSA; representative examples of light chain ‘front’ and ‘middle’ cassette sequence are shown in FIGS. 3 and 4. Additionally, many full light chain V-segment sequences supported PTyr-BSA binding; representative light chain V-segments are shown in FIG. 5. For all PTyr-binding Fabs, the light chain ‘front’ cassette, ‘middle’ cassette or full chain was derived from the human germ-line VkI subclass. Subsequent light chain cassette or full chain libraries were constructed with the human VkI subclass sequences.

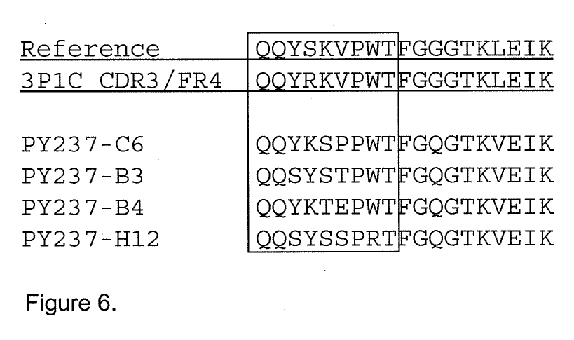

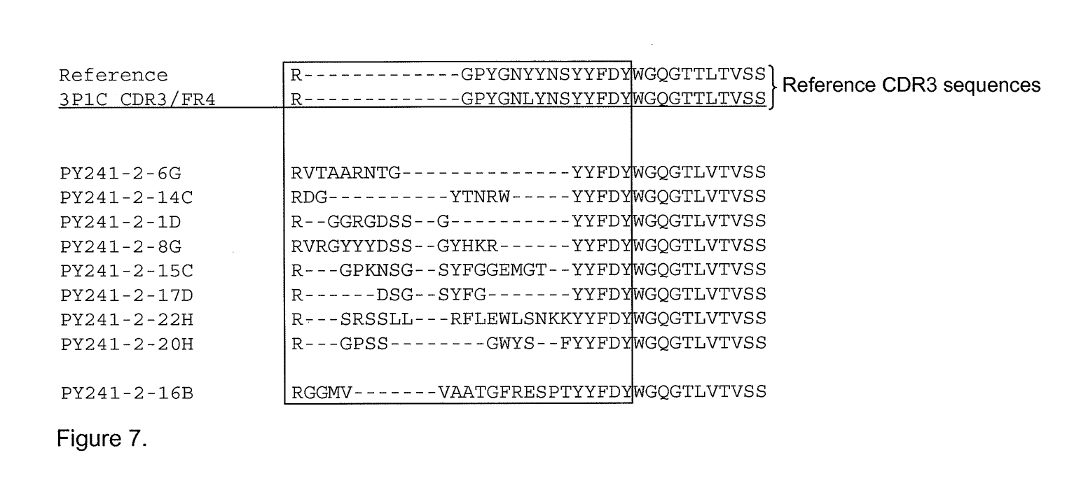

Human libraries were also made for the LCDR3/FR4 and HCDR3/FR4 cassettes. The CDR3/FR4 libraries were PCR-amplified from human spleen cDNA and ligated to reference and optimized reference V-segments. Some HCDR3 libraries included an engineered arginine residue at position 1 of the CDR3; the arginine is critical for high affinity phosphotyrosine binding (Ruff-Jamison, S. and Glenney, J. R. Prot Engineering 6: 661-668 [1993]). The LCDR3/FR4 and HCDR3/FR4 cassette libraries were cloned into a Fab expression construct along with the complementary chain. The cassette libraries were screened by CLBA for Fabs that bound PTyr-BSA. There were many CDR3/FR4 sequences identified that support PTyr-BSA binding and representative LCDR3/FR4 and HCDR3/FR4 cassettes are shown in FIGS. 6 and 7, respectively.

The results from the heavy and light chain cassette and V-region screens indicate that many diverse human V-segment and CDR3/FR4 cassette sequences support PTyr-BSA binding. In order to create a highly diverse library of Humaneered Fabs that bind PTyr-BSA, the cassettes and full chains that support PTyr-BSA binding were combined in all combinations. The resulting library, PY266, contained >10⁸ Fab sequence combinations, >50% of which bind PTyr-BSA with high affinity.

### Preparation of Phosphotyrosine-Labeled Antigens

### Peptide Antigens

Peptide antigens were synthesized using standard Fmoc SPPS (solid phase peptide synthesis). The tyrosine was incorporated into the peptide using Fmoc-Tyr (PO(OBzl)OH)—OH and the phosphotyrosine was incorporated using N-alpha-Fmoc-O-benzoyl-L-phosphotyrosine. The peptides were cleaved from the resin and de-protected using standard chemistries. The peptides were purified with reverse phase C18 column chromatography and were eluted from the column with an increasing gradient of acetonitrile.

### Protein Antigens

The single tyrosine in a chemokine protein was converted to phosphotyrosine by purified Src kinase in an in vitro reaction. 5 mg of chemokine protein was mixed with an initial 50 ug Src kinase in 2.4 ml of reaction buffer (8 mM MOPS pH 7, 0.2 mM EDTA, 10 mM MgCl₂, 10 mM ATP). The reaction mixture was incubated for 4 hr at 33° C. An additional 12.5 ug of Src kinase was added after 4 hr, 8 hr and 24 hr of for a total incubation time of 28 hr incubation at 33° C. The phosphorylated chemokine protein was run on a denaturing polyacrylamide gel and the protein was visualized with Coomassie stain. The phosphorylated chemokine and chemokine proteins migrate with a different mobility during electrophoresis; an estimated 70% of the starting chemokine protein was phosphorylated.

### Example 2

### Identification of an Antibody that Binds a Peptide

For an exemplary antigen, a 22 amino acid region of the VEGF protein (NCBI Acc.# AAB35371; positions 55-76 of the VEGF protein) was synthesized with a tyrosine or a phosphotyrosine amino acid at position 65. A light chain V-region library was prepared in which diverse, human Vk segments were ligated to the 3P1C CDR3 BSD/FR4 region. The complementary heavy chains were a mixture of Humaneered V-segments containing HCDR2 variants, all attached to the 3P1C CDR3 BSD/FR4. The resulting library, PY256, was screened by CLBA. A Fab, PY256-P-5F was recovered that showed strong binding to PTyr-labeled VEGF peptide and weak binding to the non-phosphorylated VEGF peptide of the same sequence. The Fab binding results are shown in Table 4.

In order to increase the affinity of PY256-P-5F to the non-phosphorylated VEGF peptide, a diverse human heavy chain CDR3/FR4 cassette library was prepared from human spleen cDNA and screened. The heavy chain CDR3/FR4 cassette library was ligated to the heavy chain segment from PY256-P-5F. The heavy chain CDR3/FR4 cassette library was paired with the PY256-P-5F light chain to create the PY257 Fab expression library.

PY257 was screened by CLBA using the non-phosphorylated VEGF peptide as antigen. One Fab, PY257-2D, bound the antigen strongly and was chosen for further analysis. As shown in Table 4, ForteBio Octet kinetic analysis of PY257-2D shows that the Fab has a slower off-rate than PY256-P-5F for the non-phosphorylated VEGF peptide. Thus the PY257-2D Fab binds the VEGF peptide antigen more tightly than PY256-P-5F, suggesting that additional contacts to the antigen are responsible for the stronger binding. The PY257-2D Fab also shows high affinity binding to the phosphorylated tyrosine VEGF peptide.

An additional diverse, human heavy chain ‘front’ cassette library was prepared and was substituted into the PY257-2D heavy chain. The heavy chain ‘front’ cassette library was paired with the PY256-P-5F light chain to create the PY269 Fab expression library. The PY269 library was screened by CLBA with the non-phosphorylated VEGF peptide antigen. One Fab binder, PY269-3A, was selected that showed high affinity for the non-phosphorylated VEGF peptide. The PY269-3A front cassette was human and is a different sequence than the front cassette in PY257-2D. The binding kinetics of PY269-3A to the non-phosphorylated VEGF peptide were determined in the ForteBio Octet and the results are shown in Table 4.

Additionally, the V-regions from PY269-3A were inserted into a mammalian IgG expression vector and the resulting plasmid PY3A was used to transiently transfect CHO 5035 cells. The expressed PY1E IgG was purified from the media by Protein A chromatography. The binding kinetics of purified PY3A IgG were determined on the ForteBio Octet and the bivalent affinity values are shown in Table 4. PY3A has a binding affinity of 3.3 nM to the non-phosphorylated VEGF peptide.

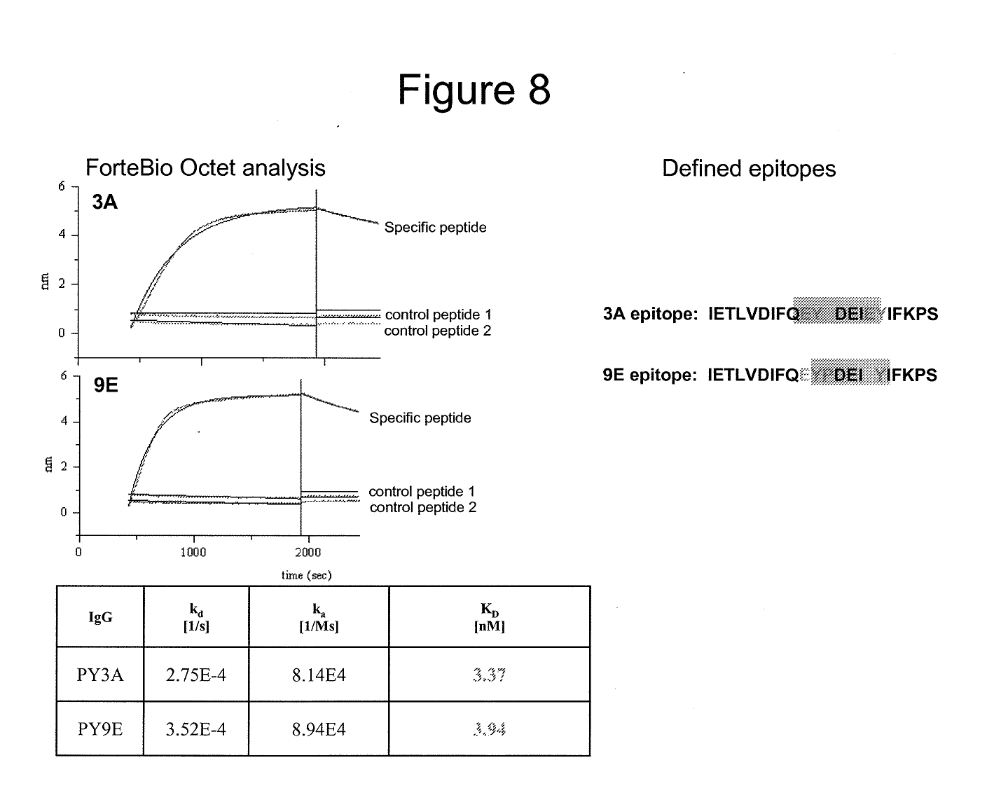

In summary, a diverse, epitope-focused engineered phosphotyrosine binding library was constructed and screened. One Fab (PY257-P-5F) was identified that bound phosphorylated VEGF peptide antigen with high affinity and non-phosphorylated VEGF peptide antigen with low affinity. Additional heavy chain CDR3/FR4 and ‘front’ cassette libraries were constructed and tested for binding to the non-phosphorylated VEGF peptide. Heavy chain CDR3/FR4 and ‘front’ cassettes were selected that provide additional affinity for the non-phosphorylated VEGF peptide antigen. The PY3A IgG was constructed using the V-regions from the PY269-3A Fab. PY3A has a bivalent affinity of 3.3 nM to non-phosphorylated VEGF peptide, showing that high affinity binding to a targeted epitope has been achieved (FIG. 8).

### Example 3

### Identification of an Antibody that Binds to a Chemokine Peptide

For a second example of an antigen, a 22-mer peptide was designed that corresponds to the terminal 22 amino acids of a mature human chemokine protein. The chemokine peptide antigen has a single tyrosine residue (at position 129 of the mature protein) that was phosphorylated. The single tyrosine in the mature chemokine protein was also phosphorylated by src kinase.

The PY266 library is a diverse collection of engineered Fabs that bind phosphotyrosine. The PY266 Fab library was screened by CLBA for binders to phosphotyrosine-labeled chemokine peptide antigen. >10% of the PY266 Fabs bound phosphotyrosine-labeled chemokine peptide. 25 Fab binders from the PY266 library that bound phosphotyrosine-labeled chemokine peptide strongly in an ELISA assay were selected. The 25 heavy and light chains were mixed in all pair-wise combinations resulting in the PY294 Fab expression library. The PY294 library was screened by CLBA again using the phosphotyrosine-labeled chemokine peptide antigen. Many Fabs binders were detected and were tested in an ELISA assay using phosphotyrosine-labeled chemokine peptide and PTyr-BSA antigens. From this screen one Fab (PY294-28D) showed higher affinity to phosphotyrosine-labeled chemokine peptide than to PTyr-BSA; this result suggests that the PY294-28D Fab binds to phosphotyrosine as well as to additional amino acids on the chemokine peptide. The binding kinetics of the PY294-28D Fab were determined on the ForteBio Octet and are shown in Table 5.

In order to increase the affinity of PY294-28D to phosphotyrosine-labeled chemokine peptide, additional cassette libraries were prepared and tested. A diverse, human heavy chain ‘front’ cassette library (PY505) was made and used to replace the single human ‘front’ cassette in PY294-28D. The PY505 library was screened by CLBA with the phosphotyrosine-labeled chemokine peptide antigen. Several binders were selected and tested by ELISA for phosphotyrosine-labeled chemokine peptide and phosphotyrosine binding. One Fab, PY505-6, showed stronger binding to the phosphotyrosine-labeled chemokine peptide antigen than to phosphotyrosine compared to the parent Fab, PY294-28D. The binding kinetics of PY505-6 were determined by ForteBio Octet analysis and the data are shown in Table 5. The PY505-6 Fab shows high affinity binding to phosphotyrosine-labeled chemokine peptide, suggesting an additional contact to the antigen was provided by selected ‘front’ cassette. Additionally, PY505-6 binds PTyr-BSA poorly, indicating that phosphotyrosine binding alone is not sufficient to account for peptide antigen binding.

To further increase affinity to the phosphotyrosine-labeled chemokine peptide and to find Fabs that bind non-phosphorylated chemokine protein, a heavy chain CDR2 diversity library was constructed and inserted into the parent PY505-6 heavy chain by overlap extension PCR. The resulting Fab library, PY741, was screened by CLBA for binders to the phosphotyrosine-labeled chemokine peptide. Many Fab binders were identified and the phosphotyrosine-labeled chemokine peptide binding was confirmed by ELISA and ForteBio Octet analysis (Table 5). The selected Fabs were also tested for binding to non-phosphorylated, unlabeled chemokine protein. One of the binders, PY741-4IC, had HCDR2 changes from the PY505-6 parent and showed binding in an ELISA assay to both the phosphorylated and non-phosphorylated, unlabeled chemokine proteins.

The PY741-4IC Fab was re-formatted as an IgG by assembly with human immunoglobulin gamma-1 constant region and expressed in Chinese Hamster Ovary cells. Binding of the PY741-4IC IgG antibody to biotinylated chemokine was determined by surface plasmon resonance analysis. The binding kinetics are shown in Table 6. The 4IC antibody binds to chemokine in the absence of phosphorylation with high affinity and represents an antibody directed to an epitope specified by hapten-targeting

### Example 4

### Identification of Antibodies that Bind Chemokine Protein

A chemokine protein was labeled with PTyr at a single tyrosine residue. The PY266 library is a diverse collection of Humaneered Fabs that bind phosphotyrosine. The PY266 Fab library was screened by CLBA for binders to phosphotyrosine-labeled chemokine protein antigen. >50 Fab binders to the PTyr-labeled chemokine antigen were selected to create a sublibrary of high affinity antibodies. The heavy and light chain V-region DNA for each of the binders was prepared and mixed in all combinations and the resulting library was screened by CLBA and by ELISA for binders to the non-phosphorylated chemokine protein. Two Fabs, PY379-2-8G and PY384-PC-9G, were identified that bind to both the phosphorylated and non-phosphoylated chemokine protein. The Fabs were tested in an ELISA assay for chemokine binding and the results are shown in Table 7. The PY379-2-8G and PY384-PC-9G Fabs bind to chemokine in the absence of phosphorylation with high affinity and represent antibodies directed to an epitope specified by hapten-targeting.

### Example 5

### Phosphorylation of Selected Tyrosine Residues in the Extracellular Domain of EphA3

This example illustrates an additional method to phosphorylate residues of interest. To phosphorylate different tyrosines on the extracellular domain of the receptor tyrosine kinase EphA3, Src and EGFR tyrosine kinases were used. Optimal conditions for Src and EGFR phosphorylation of EphA3 included 20 mM MOPS buffer pH 8.0 in the presence of 1 mM EDTA, 0.01% Briji-35, 5% glycerol, 15 mM MgCl₂ and 10 mM ATP. Final enzyme substrate ratio in the reaction was 1:100. Both reactions were incubated overnight at 37° C. Upon phosphorylation, the samples were analysed by Mass Spectrometry. Src kinase selectively phosphorylated Tyr42, Tyr76 and Tyr103. In samples incubated with EGFR kinase, phosphorylation of only Tyr 42 was observed.

All patents, patent applications, and other published reference materials cited in this specification are hereby incorporated herein by reference in their entirety for their disclosures of the subject matter in whose connection they are cited herein.

| | | LCDR3 | |
|---|---|---|---|
| Clone | HCDR3 Sequence | Sequence | Kd (1/sec) |
| Reference | R [symbol] Y [symbol] NY [symbol] S | [symbol] Q [symbol] SKVPWT | 6.55 × 10⁻³ |
| (KB6109) | YYFDY | | |
| 1p6b | ------R-------- | -----T--- | 1.02 |
| 1p8d | ---R----------- | -----A--- | ND |
| 2p7a | ---------R----- | -----Q--- | ND |
| 2p13c | -----Q--------- | ---R----- | ND |
| 3p1c | ------L-------- | ---R----- | 6.03 × 10⁻³ |
| 2p16d | --------------- | ---R----- | 5.94 × 10⁻³ |
| 3p14d | ------S--N----- | ----H---- | ND |

Table 1. The amino acid positions in bold were mutagenized to create HCDR3 and LCDR3 affinity
maturation libraries. The heavy chain FR4 in all cases is from the human germ-line J-region Jh4
and the light chain FR4 in all cases is from the human germ-line J-region Jk2. All of the clones
were ELISA positive with the PTyr-BSA antigen. The off-rate kinetics (kd) for all Fabs were
determined in the ForteBio Octet by binding to PTyr-BSA.
ND = Not Done.

TABLE 4

| | | | ELISA | |
|---|---|---|---|---|
| | | ELISA | Binding | |
| | | Binding to | to | Affinity to |
| | Fab | Phosphorylated | VEGF | VEGF Peptide |
| Antibody | or IgG | VEGF Peptide | Peptide | (kd; 1/sec) |
| PY207-1 | Fab | + | − | NM |
| (Reference) | | | | |
| PY256-P-5F | Fab | ++ | +/− | NM |
| PY257-2D | Fab | +++ | ++ | 617 nM (6 × 10⁻²) |
| PY269-3A | Fab | ++++ | +++ | 177 nM (5.73 × 10⁻³) |
| PY 3A IgG | IgG of | NT | NT | 3.37 nM (2.75 × 10⁻⁴) |
| | PY269-3A | | | |

Summary of ELISA binding and ForteBio Octet affinity measurements for selected Fabs. PY207-1 is a reference Fab with the 3p1C affinity matured LCDR3 and HCDR3 sequences.
NT = Not tested
NM = Not measurable

TABLE 5

| | | Phosphotyrosine chemokine |
|---|---|---|
| | PTyr-BSA | peptide |
| Fab | kd (1/sec) | kd (1/sec) |
| PY207-1 | 3.32 × 10⁻² | 3.22 × 10⁻² |
| (Reference) | | |
| PY294-28D | 7.84 × 10⁻³ | 4.69 × 10⁻³ |
| PY505-6 | NM | 1.99 × 10⁻³ |
| PY741-4IC | ND | 3.23 × 10⁻³ |

Forte BioOctet affinity analysis of Fab binding to selected antigens. PY207-1 is a reference Fab with the 3P1C affinity matured LCDR3 and HCDR3 sequences and human germ-line FR4s. Only the kd (off-rate) is shown.
ND = Not detectable
NM = Not measurable

TABLE 6

| | ka (1/Msec) | kd (1/S) | KD (nM) |
|---|---|---|---|
| PY741-4IC IgG | 1.45 × 10⁵ | 3.23 × 10⁻³ | 22.7 |

Binding of 4IC IgG to chemokine protein determined by surface plasmon resonance analysis (Biacore 3000). The PY741-4IC Fab was re-formatted as an IgG and its affinity to biotinylated chemokine protein was determined by surface plasmon resonance analysis.

TABLE 7

| | | | SA-HRP |
|---|---|---|---|
| | PTyr- | | (negative |
| | Chemokine | Chemokine | control |
| Fab | Protein | Protein | protein) |
| PY207-1 | +++++ | − | − |
| (opReference Fab) | | | |
| PY379-2-8G | + | + | − |
| PY384-PC-9G | ++ | ++ | − |

ELISA analysis of Fab binding to phosphorylated and non-phosphorylated chemokine protein. An ELISA plate was coated with a murine Mab that captures human Fab protein. Phosphorylated and non-phosphorylated chemokine protein antigen was biotinylated at the N-terminus and bound to streptavidin-horse radish peroxidase (HRP). The antigen: streptavidin-HRP conjugates were added to the captured Fab and after incubation, the conjugate bound to captured Fab was detected by adding a chemiluminescent HRP substrate. The binding affinity is indicated by the number of plus symbols; no binding is indicated by a minus symbol.

What is claimed is:

1. A method of obtaining an antibody to an epitope of interest, the method comprising:
(a) screening an anti-hapten focused library with a hapten-labeled epitope comprising the epitope of interest joined to a hapten;
(b) identifying members of the anti-hapten focused library that bind to the hapten-labeled epitope to generate a sublibrary of the anti-hapten focused library;
(c) screening the sublibrary of step (b) with the epitope of interest that is not attached to the hapten; and
(d) selecting an antibody that binds to the epitope, thereby obtaining an antibody to the epitope of interest.

2. The method of claim 1, wherein the members of the anti-hapten focused library retain a minimal essential binding specificity determinant from the reference antibody CDR1 or CDR2V_{H} or V_{L} region.

3. The method of claim 1, wherein the members of the anti-hapten focused library retain a minimal essential binding specificity determinant from the reference antibody CDR3V_{H} or V_{L} region.

4. The method of claim 1, wherein the members of the anti-hapten focused library retain a minimal essential binding specificity determinant from the reference antibody heavy chain CDR2 and a minimal essential binding specificity determinant from the reference antibody light chain CDR3.

5. The method of claim 1, wherein the step of screening the anti-hapten antibody library with the hapten-labeled epitope further comprises screening the anti-hapten antibody library with a hapten comparator molecule; and selecting an antibody that exhibits increased binding to the hapten-labeled epitope relative to the binding to the hapten comparator molecule.

6. The method of claim 1, wherein the hapten is a modified tyrosine residue.

7. The method of claim 1, wherein the hapten is a naturally occurring modified amino acid.

8. The method of claim 1, wherein the hapten is a phosphorylated amino acid.

9. The method of claim 8, wherein the phosphorylated amino acid is phosphotyrosine, phosphoserine, or phosphothreonine.

10. The method of claim 9, wherein the phosphorylated amino acid is phosphotyrosine.

11. The method of claim 1, wherein the hapten-labeled epitope is a peptide of from 15 to 50 amino acids in length.

12. The method of claim 1, wherein the hapten-labeled epitope is a protein antigen comprising the epitope of interest.

13. The method of claim 1, wherein about 10⁵ or fewer colonies of the anti-hapten focused library are screened.

14. The method of claim 1, further comprising:
(e) selecting one of the V regions of the antibody selected in (d) and exchanging a cassette of the selected V region with a library of corresponding cassettes to provide a library of engineered V regions, wherein the selected V region retains at least one minimal essential binding specificity determinant of a CDR from the antibody selected in (d);
(f) pairing the V region library of step (e) with the complementary V region from the antibody selected in step (d) to form a library of antibodies;
(g) screening the library of step (f) with the epitope of interest that is not attached to the hapten; and
(h) selecting an antibody that binds to the epitope wherein the antibody comprises an engineered V region.

15. The method of claim 14, wherein the antibody selected in step (h) no longer binds to the hapten.

16. The method of claim 14, wherein the selected V region is a heavy chain V region.

17. The method of claim 14, wherein the at least one minimal binding specificity determinant retained is from a CDR3.

18. The method of claim 14, wherein the cassette that is exchanged in step (e) is a CDR3-FR4 cassette.

19. The method of claim 14, further comprising:
(i) selecting the engineered V region from the antibody selected in step (h) and exchanging another cassette of the engineered V region with a library of corresponding cassettes, wherein the selected V region retains at least one minimal essential binding specificity determinant from a CDR from the antibody selected in (h);
(j) pairing the V region library of step (i) with the complementary V region of the antibody selected in (h) to form an antibody library;
(k) screening the antibody library of step (j) with an epitope of interest that is not attached to the hapten; and
(l) selecting an antibody that binds to the epitope, thereby obtaining an antibody to an epitope of interest.

20. The method of claim 1, wherein the antibody is a Fab.

21. The method of claim 20, wherein the antibody is secreted.

22. The method of claim 1, wherein the anti-hapten focused library is a display library.

23. The method of claim 22, wherein the display library is a phage display library.

24. The method of claim 1, wherein the anti-hapten focused library that comprises binding members that:
retain the binding specificity of a reference anti-hapten antibody and comprise at least one heavy chain CDR minimal essential binding specificity determinant from the reference anti-hapten antibody and at least one light chain CDR minimal essential binding specificity determinant from the reference anti-hapten antibody; and have at least one diverse exchange cassette.
